(19) United States
(12) Patent Application Publication
(10) Pub. No.: US 2008/0176121 A1
(43) Pub. Date: Jul. 24, 2008

(54) FUEL BATTERY SYSTEM AND DEVICE FOR TERMINAL USING THE FUEL BATTERY SYSTEM

(75) Inventor: Kunio YAMAMIYA, Sagamihara-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS IMAGING CORP., Tokyo (JP)

(21) Appl. No.: 11/873,787

(22) Filed: Oct. 17, 2007

(30) Foreign Application Priority Data
Oct. 18, 2006 (JP) 2006-284196

(51) Int. Cl. H01M 8/04

(52) U.S. Cl. 429/24; 429/25; 429/34

(57) ABSTRACT

In a system, a first or second opening and closing valve, a first or second pressure sensor for detection, and a first or second pressure adjusting valve are disposed between a hydrogen storing alloy container and a fuel battery cell, and the first or second opening and closing valves or the first or second pressure sensor for detection and first or second safety valve are directly connected to each other. A fine flow passage of at least one system and a temperature sensor provided near the flow passage or on a terminal device are provided between a first pipe connected to the hydrogen storing alloy container and a second pipe connected to the fuel battery cell. An opening and closing valve being used at a time of an abnormality occurrence remains open or is closed and the safety valve is opened according to an output of the temperature sensor.

### CROSS-REFERENCE TO RELATED APPLICATIONS

This application is based upon and claims the benefit of priority from prior Japanese Patent Application No. 2006-284196, filed Oct. 18, 2006, the entire contents of which are incorporated herein by reference.

### BACKGROUND OF THE INVENTION

1. Field of the Invention

The present invention relates to a fuel battery system that uses a fuel battery, such as of the hydrogen type, as a power source for a portable or mobile electronic device or the like, and a device for a terminal using the fuel battery system.

2. Description of the Related Art

Fuel batteries such as those of hydrogen or methanol types, are expected to be put to use for various information or data processing apparatuses, such as a video camera, a notebook-type personal computer, a mobile phone, a Personal Digital Assistant (PDA), or an audio player, or the like due to their reduced weight, increased convenience, and other advantages.

The present invention relates to a hydrogen storing alloy container to which a hydrogen storing alloy material is applied, and a fuel battery system using the same; more specifically, it relates to use of a fuel battery system in a mobile or portable device.

For example, Jpn. Pat. Appln. KOKAI Publication No. 2006-24028 has disclosed a micromini pressure-reducing flow rate control apparatus provided with an opening and closing valve and a first fine fluid flow passage that allows flow of fluid and reduces pressure of the fluid, N (N is an integer of at least 2) second fine fluid flow passages that allow flow of fluid from the first fine fluid flow passage, micro-valves provided in the respective fine fluid flow passages, and a fluid collecting flow passage that collects fluids from the respective fine fluid flow passages in one flow to output the same to the outside.

Further, a temperature compensating member that thermally expands to reduce a sectional area of each fine fluid flow passage corresponding to a temperature rise is disposed in the first fine fluid flow passage or each second fine fluid flow passage.

Jpn. Pat. Appln. KOKAI Publication No. 2006-164872 has disclosed a fuel supplying apparatus of a fuel battery that supplies fuel to a plurality of fuel cells through fuel introducing passages branched from a fuel tank individually, where a plurality of individual piezoelectric type or electromagnetic type fuel valves corresponding to the plurality of cells are provided, portions of the fuel introducing passages positioned on output sides of the fuel valves are connected to the fuel cells, and portions of the fuel introducing passages on input sides of the fuel valves are collectively connected to one fuel pump.

Furthermore, Jpn. Pat. Appln. KOKAI Publication No. 2004-362786 has disclosed an apparatus provided with a hydrogen relief valve 51 that releases hydrogen from a hydrogen storing container 1 to the outside when a temperature in a tank or a hydrogen pressure reaches at least a predetermined value. In the apparatus, a piping route A5, a primary pressure detecting mechanism 30, a pressure adjusting mechanism 20, a secondary pressure detecting mechanism 31, and a piping route B5 to a fuel battery cell 3 are arranged in this order from hydrogen storing alloy 2.

### BRIEF SUMMARY OF THE INVENTION

Accordingly, an object of the present invention is to provide a fuel battery system in which a hydrogen storing alloy casing can improve the abnormality detecting accuracy regarding a temperature or a pressure within a fine fluid flow passage in the fuel battery system and can protect a pressure adjusting valve, and a device for a terminal using the fuel battery system.

That is, according to a first object of the present invention, there is provided a fuel battery system comprising a hydrogen storing alloy container; a first pipe whose one end is connected to the hydrogen storing alloy container; a fuel battery cell; a second pipe whose one end is connected to the fuel battery cell; a fine fluid flow passage of a least one system that is disposed between the other end of the first pipe and the other end of the second pipe and includes an opening and closing valve, a pressure sensor for detection, and a pressure adjusting valve that are arranged, where the opening and closing valve or the pressure sensor for detection and a safety valve are directly connected to each other; and a temperature sensor, wherein,

the temperature sensor is disposed near the fine fluid flow passage, and,

in a state that the opening and closing valve being used at an occurrence time of abnormality remains open or after the opening and closing valve being used at an occurrence time of abnormality is closed according to an output from the temperature sensor, the safety valve is opened.

According to a second object of the present invention, there is provided a fuel battery system comprising a hydrogen storing alloy container; a first pipe whose one end is connected to the hydrogen storing alloy container; a fuel battery cell; a second pipe whose one end is connected to the fuel battery cell; a fine fluid flow passage of a least one system and an auxiliary fine fluid flow passage, each being disposed between the other end of the first pipe and the other end of the second pipe and including an opening and closing valve, a pressure sensor for detection, and a pressure adjusting valve that are arranged, where the opening and closing valve or the pressure sensor for detection and a safety valve are directly connected to each other; and a temperature sensor, wherein,

the temperature sensor is disposed near the fine fluid flow passage, and,

according to an output from the temperature sensor, the opening and closing valve in either of the fine fluid flow passages is closed and the safety valve in the auxiliary fine fluid flow passage is opened.

According to a third object of the present invention, there is provided a device for a terminal provided with a fuel battery system comprising a hydrogen storing alloy container, a first pipe whose one end is connected to the hydrogen storing alloy container, a fuel battery cell, a second pipe whose one end is connected to the fuel battery cell, and a fine fluid flow passage of at least one system and an auxiliary fine fluid flow passage, each being disposed between the other end of the first pipe and the other end of the second pipe and including an opening and closing valve, a pressure sensor for detection, and a pressure adjusting valve that are arranged between the hydrogen storing alloy container and the fuel battery cell, where the opening and closing valve or the pressure sensor for detection and a safety valve are directly connected to each other; a secondary battery; a temperature sensor for a unit; and a control circuit, wherein,

when the control circuit determines that a temperature in the fuel battery system is abnormal based upon an output signal from the temperature sensor for a unit, the control circuit opens the safety valve in a state that the opening and closing valve being used remains open or after closing the opening and closing valve being used.

According to a fourth object of the present invention, there is provided a device for a terminal comprising a fuel battery system comprising a fine fluid flow passage of at least one system and an auxiliary fine fluid flow passage, each including an opening and closing valve, a pressure sensor for detection, and a pressure adjusting valve that are disposed between a hydrogen storing alloy container and a fuel battery cell; a secondary battery; a temperature sensor for a unit, and a control circuit, wherein,

when the control circuit determines that a temperature in the fuel battery system is abnormal based upon an output signal from the temperature sensor for a unit, the control circuit closes the opening and closing valve in either of the fine fluid flow passages and opens the safety valve in the auxiliary fine fluid flow passage after closing the opening and closing valve being used.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A is a sectional view showing a configuration of a fuel battery system according to a first embodiment of the present invention, and FIG. 1B is a configuration diagram showing an arrangement example of a base board for terminals 50 shown in FIG. 1A;

FIG. 2 is a sectional view showing a specific configuration of a pressure adjusting mechanism of the fuel battery system 10 shown in FIG. 1A;

FIGS. 3A and 3B are block configuration diagrams of two kinds of fuel battery systems according to the first embodiment of the present invention;

FIG. 4A is a table representing one example of data items stored in a ROM, and FIG. 4B is a table representing another example of data items stored in a ROM;

FIGS. 5A and 5B are block configuration diagrams of a further two kinds of fuel battery systems according to the first embodiment of the present invention;

FIG. 6 is a block diagram showing a schematic configuration of a main portion of a control circuit in the fuel battery system;

FIG. 7 is a flowchart for explaining an operation of the fuel battery system according to the first embodiment of the present invention;

FIG. 8 is a flowchart for explaining a specific operation of a subroutine “temperature sensor abnormality detection” at step S6 in the flowchart shown in FIG. 7;

FIG. 9 is a flowchart for explaining an operation performed when first and second pressure sensors for detection are removed from the fuel battery system, an auxiliary pressure sensor for detection is disposed between an auxiliary valve and an auxiliary pressure adjusting valve, and a safety valve is disposed at a position branched from between the auxiliary pressure sensor for detection and the auxiliary pressure adjusting valve;

FIG. 10 is a timing chart for explaining an operation of the safety valve;

FIG. 11 is a diagram for explaining an application voltage from a pressure sensor for detection to a pressure adjusting valve when various hydrogen storing alloys are used;

FIG. 12 is a pressure-remaining amount diagram regarding a plurality of temperature characteristics;

FIG. 13A is a block configuration diagram for explaining a combination of a fuel battery system and remaining amount display of an electronic device incorporated with a secondary battery and a CPU, and FIG. 13B is a block configuration diagram schematically showing a configuration of a peripheral portion of a selector switch 226 in FIG. 13A;

FIGS. 14A-14C are diagrams showing display examples on a screen of a fuel battery selected according to user designation;

FIGS. 15A and 15B are sectional views showing one example of a fuel battery system including a safety valve comprising an electromagnetic actuator, FIG. 15A showing a state that the safety valve has been closed while FIG. 15B showing a state that the safety valve has been opened;

FIGS. 16A and 16B are sectional views showing one example of a fuel battery system including an opening and closing valve comprising a heat generator actuator, FIG. 16A showing a state that the opening and closing valve has been closed while FIG. 16B showing a state that the opening and closing valve has been opened;

FIGS. 17A and 17B are sectional view showing one example of a fuel battery system including an opening and closing valve made from shape-memory alloy, FIG. 17A showing a state that the opening and closing valve has been closed while FIG. 17B showing a state that the opening and closing valve has been opened;

FIG. 18 is a diagram showing a configuration of a fuel battery system according to a second embodiment of the present invention;

FIG. 19 is a diagram for explaining an operation of the fuel battery system with a configuration shown in FIG. 18;

FIG. 20 is a block diagram showing a configuration of a fuel battery system according to a third embodiment of the present invention; and

FIG. 21A is a block diagram showing a configuration of an electronic device system as a modification according to a third embodiment of the present invention, and FIG. 21B is a table showing operation states of switches 430a, 430b, and 430c shown in FIG. 21A.

### DETAILED DESCRIPTION OF THE INVENTION

Embodiments of the present invention will be explained below with reference to the drawings.

### First Embodiment

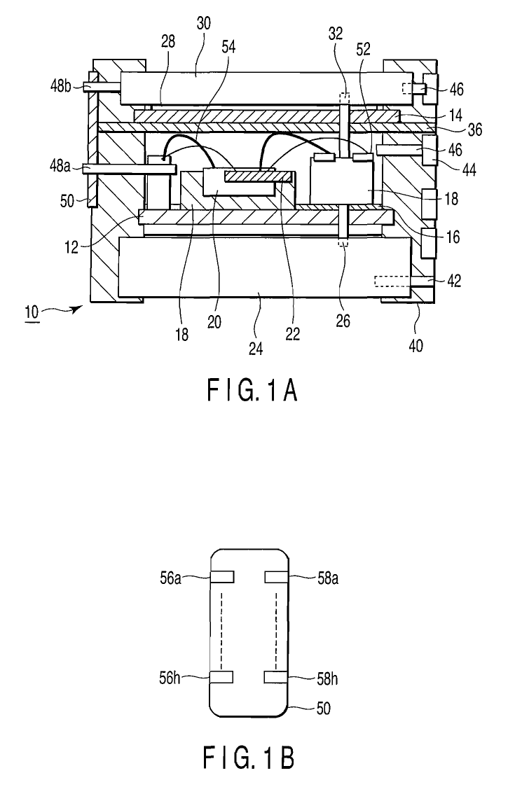

FIG. 1A is a sectional view showing a configuration of a fuel battery system according to a first embodiment of the present invention.

In FIG. 1A, a fuel battery system 10 is configured by providing, in a hydrogen storing alloy container casing 40, an upper layer of a hydrogen flow passage where a pressure adjusting mechanism having a function for adjusting a hydrogen pressure occurring when hydrogen is supplied to a fuel battery cell 30 to a balance pressure of hydrogen storing alloy or less is formed on a silicon substrate 18 and a lower layer of a hydrogen flow passage provided by a first silicon substrate 16 formed on a first glass substrate 12.

The first silicon substrate 14 and the second silicon substrate 16 are disposed on the first glass substrate 12. A temperature sensor 20 and a head amplifier chip (HA chip) 22 for an amplitude signal amplifying circuit are embedded in the second silicon substrate 18 placed on the first glass substrate 12. On the other hand, a piping route A26 and a piping route B32 are provided in the second silicon substrate 18 on the first silicon substrate 16. The piping route A26 extends to a hydrogen storing alloy container 24 through the first glass substrate 12. The piping route B32 extends to a fuel battery cell 30 through the second glass substrate 14 and a heat insulating member 28. The piping route A26 and the piping route B32 are connected for supplying hydrogen to the fuel battery cell 30.

The second glass substrate 14 is bonded to a retaining plate 36 made from synthetic resin so as to be positioned in parallel to the first glass substrate 12. The second glass substrate 14 is provided for preventing respective pressure sensors and a fluid device of a pressure adjusting valve disposed in a space between the second glass substrate 14 and the first glass substrate 12 from being subjected to electrostatic breakdown. A structure for thermally insulating the fuel battery cell unit 30 side and a hydrogen storing alloy container casing 40 supporting the hydrogen storing alloy container 24 from each other is provided by interposition of a heat insulating member 28 disposed on the retaining plate 36 made from the synthetic resin. That is, by blocking transfer or conduction of heat generated from the fuel battery cell unit 30 to the hydrogen storing alloy container 24, rapid temperature rising of the hydrogen storing alloy container 24 can be suppressed.

The fuel battery cell 30 is for utilizing hydrogen as fuel to supply power. The fuel battery cell 30 is brought in close contact with the retaining plate 36 made from synthetic resin via the heat insulating member 28, which is vacuum heat insulating material obtained by utilizing conductive powder as core material, sealing the core material in a bag formed of nonwoven fabric, and covering the bag with an outer skin. When the vacuum heat insulating material is used, a thickness of the heat insulating member 28 reaches several mm, so that it is desirable that the vacuum heat insulating material is directly bonded to the hydrogen storing alloy container casing 40 without using the retaining plate 36.

A hydrogen replenishing port 42 is provided in the hydrogen storing alloy container 24 and the hydrogen storing alloy casing 40. The hydrogen replenishing port 42 is a removable port and it has such a mechanism that a valve is opened at a connecting time. A hydrogen replenishing bomb such as a hydrogen generator generating hydrogen by discharging of methanol, ethanol, dimethyl ether, or the like is connected to the hydrogen replenishing port 42 for injection so that hydrogen is replenished and stored in the hydrogen storing alloy in the hydrogen storing alloy container 24.

The hydrogen storing alloy container 24 has a rectangular parallelepiped shape with a short size in a thickness direction, and the fuel battery cell 30 is disposed so as to come in close contact with the hydrogen storing alloy container 24 in the thickness direction. As one example of an outer size of the hydrogen storing alloy container casing 40, such metal as aluminum or stainless steel is used as the material for configuring the rectangle-shaped hydrogen storing alloy container casing 40 such that the hydrogen storing alloy container casing 40 can bear pressure from the hydrogen storing alloy container 24. When the material is aluminum, a plurality of cooling fins having undulation in a vertical direction perpendicular to a drawing sheet for FIG. 1A are formed on an outer surface of the hydrogen storing alloy container casing 40 by forming many grooves or the like.

An air intake port 46 is inserted in between the fuel battery cell 30 or the first glass substrate 12 and the second glass substrate 14. By providing an opening in a groove of the fin 44 except for one face of the hydrogen storing alloy container casing 40 to which the a base board 50 for terminals is mounted, the air intake port 46 can suck air without being obstructed by a leaf spring member (not shown) for pressing a mobile device to terminals of the board 50 for terminals at an insertion time to the mobile device.

By disposing the heat insulating member 28 between the fuel battery cell 30 and the retaining plate 36, heat generated from the fuel battery cell 30 can be isolated so that erroneous detection of the temperature sensor 20 disposed on the second silicon substrate 18 can be prevented. Further, pin terminals 48a and 48b are joined to the base board 50 for terminals. The pin terminal 48a, the temperature sensor 20, the HA chip 22, and a relay terminal substrate 52 are connected by a bonding wire 54.

The connection portions or depressed portions to which bonding wires 54 connected to the electronic components (e.g., the temperature sensor 20), pin terminals and base board 50 for terminals on the silicon substrates 16 and 18 are coupled, may be covered or filled with a silicon gel agent. Where this structure is adopted, the bonding wires 54 are protected from damage despite the external shock or the vibration of a vibrator located inside (the vibrator may be an image blurring-correcting element made of an actuator that drives a correction lens or an imaging element of an imaging optimal system in the direction of the optical axis). The silicon gel filled in the depressed portions does not flow out.

As shown in FIG. 1B, the board 50 for terminals is provided with 8 terminals for each of a set of signal wires 56a to 56h and a set of drive wires 58a to 58h. The signal wires 56a to 56h are for transmitting signals from a temperature sensor, a pressure sensor for detection, and a pressure adjusting valve described later to the control circuit. The drive wires 58a to 58h are for supplying power from the fuel battery cell to a device load unit and the secondary battery and supplying power to the safety valve, the pressure sensor for detection, and the pressure adjusting valve. By disposing two sets of drive wires for power supply on the same or one board for terminals, the number of assembling steps can be reduced without conducting wiring within the fuel battery system, so that the interior of the fuel battery system can be simplified. Incidentally, a space between the first glass substrate 12 and the second glass substrate 14 is configured as a pressure adjusting mechanism.

A balance pressure of a hydrogen storing alloy changes according to the temperature of the hydrogen storing alloy, and the balance pressure increase when the temperature rises. For example, when a hydrogen storing alloy including LaNi₅ of the AB5 type as a main component is used, it is preferable that the material for a hydrogen storing alloy with a balance pressure of about 0.25 to 0.35 MPa at 20° C. is used such that the balance pressure is the normal pressure or more at 0° C., it is 0.6 MPa at 45° C., and it does not exceed 1.0 MPa at 60° C., assuming that a use environment is in a range of about 0 to 45° C. The hydrogen storing alloy container casing 40 is combined with the fuel battery cell 30, and a route from the hydrogen storing container 24 to the fuel battery cell 30 is unitized so that the fuel battery system according to the embodiment is obtained. The temperature sensor 20 is provided for measuring a temperature inside the hydrogen storing alloy container casing 40.

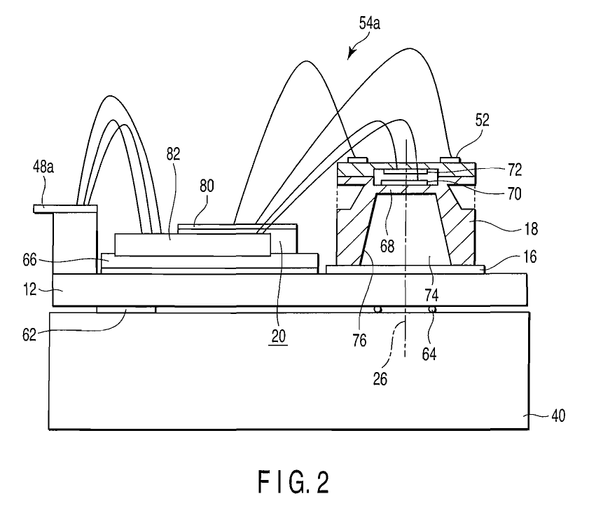

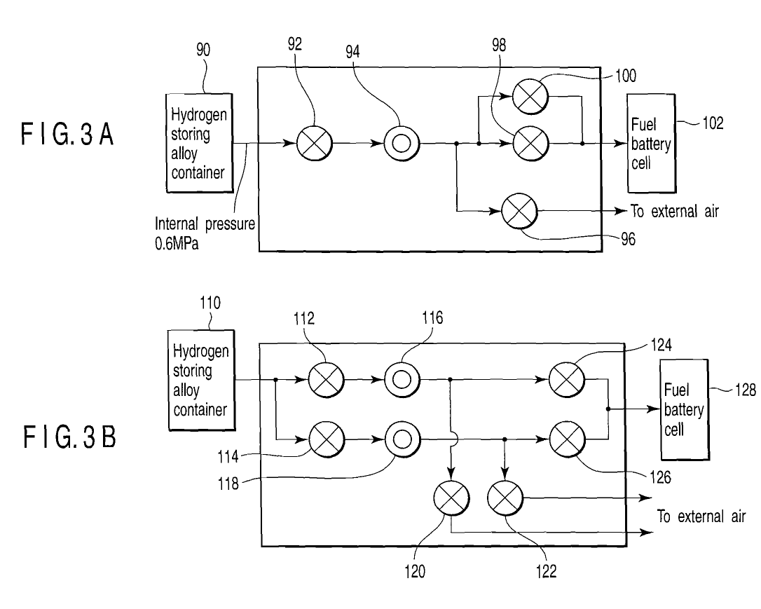

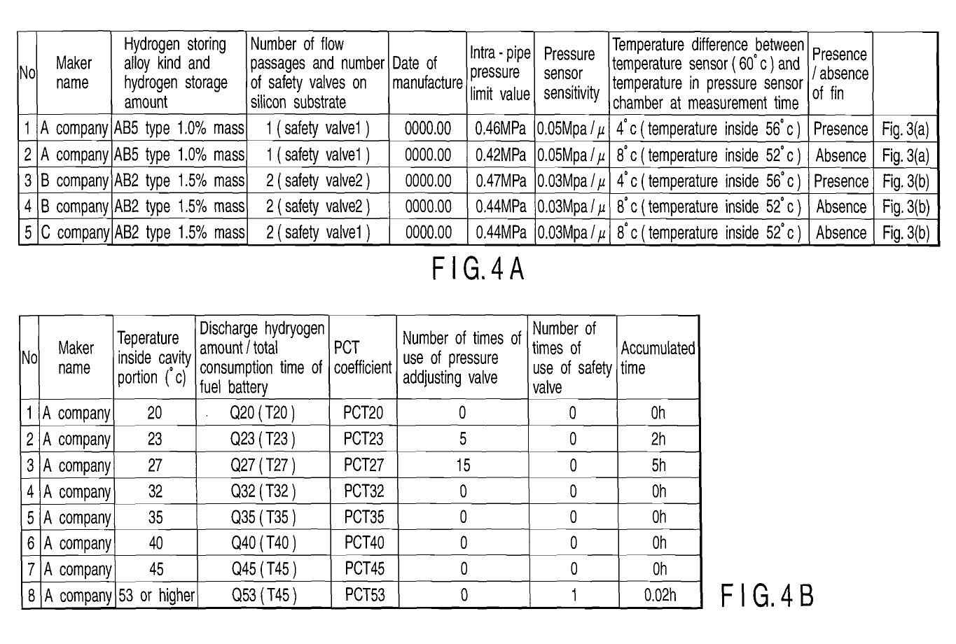

FIG. 2 is a sectional view of a pressure adjusting mechanism of the pressure sensor for detection and the pressure adjusting valve of the fuel battery system 10 shown in FIG. 1A.

In FIG. 2, the first glass substrate 12 is disposed on the hydrogen storing alloy container 24 via an inclination adjusting member 62 and an O-ring (packing member) 64. A third silicon substrate 66 is disposed on the second silicon substrate 18. Incidentally, the third silicon substrate 66 is used here, but the second silicon substrate 18 may be used, as shown in FIG. 1A.

A movable side driving electrode plate 70 joined to a diaphragm 68 is provided at an upper position on the second silicon substrate 18. A fixed side driving electrode plate 72 is provided on the relay terminal substrate 52. The movable side driving electrode plate 70 and the fixed side driving electrode plate 72 are disposed at opposite positions to each other, and they are configured so as to detect capacitance change as one set. In this case, though not illustrated, it is preferable that two sets of driving electrode plates are disposed.

The pressure sensor for detection includes a cavity portion 74 on the second silicon substrate 18 forming a flow passage on the side of its lower face. A protective film 76 for preventing the second silicon substrate 18 from corroding due to gas or the like is formed on an inner surface of the cavity portion 74.

Meanwhile, a sine wave voltage circuit 80 using a quartz oscillator and an IC chip 82 for an amplitude detecting circuit are joined to each other on an upper face of the third silicon substrate 66. Further, a plurality of pin terminals 48a are joined to an upper side of the third silicon substrate 66. Through-holes for lead wires such as the drive wires for the opening and closing valve and the safety valve, and the signal wires from the pressure sensor for detection are formed on both sides of the temperature sensor 20 shown in FIG. 1A.

The IC chip 82, the relay terminal substrate 52, and the plurality of pin terminals 48a described above are connected by a bonding wire group 54a (bonding wires 54). In an operation, the sine wave voltage circuit 80 starts driving based upon an instruction from the CPU. An output signal from the sine wave voltage circuit 80 forcibly vibrates the diaphragm 68 via a drive circuit system packaged in an IC chip for an amplitude detection circuit. When the pressure acting on the diaphragm 68 increases or decreases, the amplitude of an output signal changes correspondingly. The output signal is input into a CPU in an electronic device via a circuit for an amplitude amplification (head amplifier) of the IC chip (HA chip) 82 for an amplitude detection circuit. The CPU conducts feedback control based upon a reference value from a memory (ROM).

Further, when a small tube (capillary tube) is disposed between the hydrogen storing alloy casing and the opening and closing valve, the pressure at an actuation time of the pressure adjusting valve is lowered due to the pressure loss occurring when hydrogen passes through the small tube, so that load can be reduced by a pressure adjuster.

Here, the fuel battery system 10, the fuel battery cell 30, and the hydrogen storing alloy container 24 shown in FIG. 1A have been unitized by the hydrogen storing alloy container casing 40. However, the piping route A26 is of an attachable and detachable type and has a configuration where a valve is opened by connection thereof so that the hydrogen storing alloy container 24 can be attached to and detached from the fuel battery system 10. In this case, the temperature sensor 20 shown in FIG. 1A is not used, but a temperature sensor disposed near a disk-like storage medium or a temperature sensor for measuring a surface temperature of an IC chip for a lens driving circuit described later may be used, for example.

FIGS. 3A and 3B are block configuration diagrams of two kinds of fuel battery systems according to the first embodiment.

In FIG. 3A, a hydrogen storing alloy container 90 has been disposed inside the hydrogen storing alloy casing 40 described above. An opening and closing valve 92, a pressure sensor for detection 94, safety valve 96 a pressure adjusting valve 98, and an auxiliary pressure adjusting valve 100 are arranged through a piping route A (not shown) from the hydrogen storing alloy container 90. The pressure adjusting valve 98 and the auxiliary pressure adjusting valve 100 are connected to a fuel battery cell 102 via a piping route B (not shown).

The opening and closing valve 92 is an opening and closing valve for hydrogen replenishment provided with a valve mechanism which is opened when a power source switch of a device for a terminal is turned ON and is closed when the power source switch is turned OFF. The safety valve 96 is connected between the pressure sensor for detection 94 and an external air port. The safety valve 96 comprises a known electrostatically-actuated micro-valve or a diaphragm made from a thermally deformable conductive material (for example, shape-memory alloy material), and it has a switch function which can be turned ON (valve is opened) and OFF (valve is closed).

In FIG. 3B, first and second opening and closing valves 112 and 114, and first and second pressure sensors for detection 116 and 118 are disposed from a hydrogen storing alloy container 110 through a piping route A (not shown). First and second safety valves 120 and 122 are disposed between the first pressure sensor for detection 116 and an external air port and between the second pressure sensor for detection 118 and the external air port, respectively. First and second pressure adjusting valves 124 and 126 are disposed between the first pressure sensor for detection 116 and a fuel battery cell 128 and between the second pressure sensor for detection 118 and the fuel battery cell 128, respectively.

Next, operations at a time of replenishing hydrogen into the hydrogen storing alloy container and at a fuel battery cell driving time will be explained.

Referring to FIG. 3B, the hydrogen storing alloy container 110 includes a hydrogen replenishing port of an attachable and detachable type with such a mechanism that a valve is opened at a connecting time. The hydrogen replenishing bomb described above is connected to the hydrogen replenishing port at a hydrogen replenishing time (not shown). Hydrogen is replenished and stored in a hydrogen storing alloy in the hydrogen storing alloy container 110 via the hydrogen replenishing port. Replenished hydrogen is not only stored in the hydrogen storing alloy but also remains in the piping route, and further in the piping route from the first and second opening and closing valves 112 and 114 to the fuel battery cell 128 in a state that the opening and closing valve is closed. When a power switch of the device for a terminal is turned ON, the first and second opening and closing valve 112 and 114 are opened, hydrogen stored in the hydrogen storing alloy is supplied up to the pressure adjusting valve to be mixed with the remaining hydrogen gas so that the pressure in the piping route becomes equal to the internal pressure in the hydrogen storing alloy.

Next, output signals from detectors of the first and second pressure sensors for detection 116 and 118 are converted to a table (for example, Table shown in FIG. 4A) stored in a memory (ROM) (not shown) so that the pressure adjusting valve is opened. When the hydrogen gas pressure to the fuel battery cell 128 reaches 0.1 MPa at a hydrogen fuel battery cell operation time, the fuel battery cell 128 starts to operate. Hydrogen stored in the hydrogen storing alloy for performing replenishment corresponding to consumed hydrogen is supplied to the fuel battery cell 102 from an opening and closing valve in an example (Company A) shown in FIG. 3A, namely, the opening and closing valve 92 via the pressure sensor for detection 94 and the pressure adjusting valve 98 sequentially. The fuel battery cell 102 continuously operates while keeping the hydrogen pressure on the fuel battery cell 102 side constant, so that power is supplied to a device for a terminal (not shown) or the like stably. In this case, the pressure sensor for detection 94 and the safety valve 92 are directly connected to each other.

Incidentally, in Table shown in FIG. 4A, the hydrogen storing alloy kind, hydrogen storage amount, the numbers of safety valves and flow passages, capacitance, intra-pipe pressure limit value, pressure sensor sensitivity, and management data such as date of manufacture are stored. Further, when a discharge flow rate of the pressure adjusting valve is calculated based upon Table shown in FIG. 4A, the discharge flow rate can be found by obtaining a difference in pressure between an actual measurement value output from the pressure sensor for detection and an actual measurement value output from the pressure adjusting valve.

In the embodiment, a plurality of (two in this embodiment) opening and closing valves 112 and 114, pressure sensors for detection 116 and 118, and pressure adjusting valves 124 and 126 are arranged in parallel in an example (Company B) shown in FIG. 3B in order to reduce load acting on the pressure adjusting valves due to high pressure hydrogen gas. The first and second pressure sensors for detection 116 and 118 are directly connected to the respective first and second safety valves 120 and 122. The first and second safety valves 120 and 122 are connected to an external air port.

Each of the first and second opening and closing valves 112 and 114 and the first and second safety valves 120 and 122 comprises a known electrostatically-actuated micro-valve or a diaphragm made from a thermally deformable conductive material (for example, shape-memory alloy material), where each valve is opened according to a behavior of a diaphragm having a switch function of being capable of turning ON (valve is opened) and turning OFF (valve is closed). Incidentally, as another example (Company C), when the second safety valve is not used, it is formed as a dummy valve.

Here, in the case of Company B, after a predetermined time elapses where hydrogen gas is partially divided, when the pressure sensor for detection detects a desired value, the first opening and closing valve 112 is closed and the second opening and closing valve 114 is opened. Thereafter, the second pressure valve for detection 118 conducts monitoring. The first and second opening and closing valves 120 and 122 repeat ON and OFF operations under monitoring conducted by the pressure sensors for detection 116 and 118. When the pressure sensors for detection 116 and 118 detect desired hydrogen gas pressures, the pressure adjusting valves 124 and 126 start control and conduct control such that the pressure in the fuel battery cell 128 reaches 0.1 MPa pressure. Further, it is possible to use a plurality of opening and closing valves 112 and 114 simultaneously in order to protect the pressure adjusting valves 124 and 126.

With such a configuration that ON and OFF operations are repeated, it is desirable that chips such as a CPU or an analog switch are embedded in the second silicon substrate.

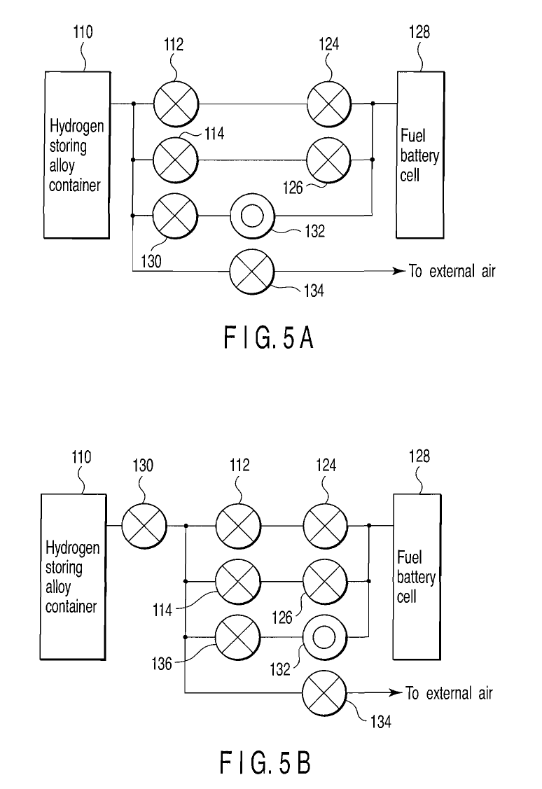

FIGS. 5A and 5B are block configuration diagrams of a further two kinds of fuel battery systems according to the first embodiment.

In a fuel battery system of Company D having a configuration example shown in FIG. 5A, an auxiliary valve 130 is also opened and closed in synchronism with valve operations of the first and second opening and closing valves 112 and 114. The fuel battery system includes the hydrogen storing alloy container 110 that is a fuel tank, and the first and second opening and closing valves 112 and 114 and the first and second pressure adjusting valves 124 and 126 that are main fine fluid flow passages connecting the hydrogen storing alloy container 110 and the fuel battery cell 128 through piping routes. Further, an auxiliary valve 130 and an auxiliary pressure sensor for detection 132 in an auxiliary fine fluid flow passage are also disposed in sequence between the hydrogen storing alloy container 110 and the fuel battery cell 128. Further, the auxiliary pressure sensor for detection 132 and the safety valve 134 are directly connected to each other.

An output from the temperature sensor and an output from the auxiliary pressure sensor for detection 132 opens the safety valve 134 and maintains the auxiliary valve 130 in an opened state based upon predetermined reference data (a predetermined value of a intra-pipe temperature limit value or an intra-pipe pressure limit value depending on a vendor for each unit and kind of hydrogen) to discharge hydrogen gas from the hydrogen storing alloy container 110 to the outside. By opening an opening and closing valve (the first or second opening valve 112 or 114) being used at a time of abnormality occurrence, (the first and second) pressure adjusting valves (124 and 126) that are first and second micro-valves can be protected.

In a fuel battery system of Company E of a configuration example shown in FIG. 5B, an auxiliary valve 130 is disposed between the hydrogen storing alloy 110 that is the fuel tank, and the first, second, and third opening and closing valves 112, 114, and 136, so that the auxiliary valve 130 is also opened and closed in synchronism with fuel battery cell operation. After the auxiliary valve 130 is opened and closed, the first, second, and third valves 112, 114, and 136 are opened. A third opening and closing valve 136 and an auxiliary pressure sensor for detection 132 in an auxiliary fine fluid flow passage are disposed in sequence between the auxiliary valve 130 and the fuel battery cell 128. The auxiliary valve 130 and the safety valve 134 are directly connected to each other.

An output from the temperature sensor and an output from the auxiliary pressure sensor for detection 132 in the pipe opens the safety valve 134 and maintains the auxiliary valve 130 in an opened state based upon predetermined reference data (a predetermined value of a intra-pipe temperature limit value or an intra-pipe pressure limit value depending on a vendor for each unit and kind of hydrogen) to discharge hydrogen gas from the hydrogen storing alloy container 110 to the outside. By opening the first or second opening and closing valve 112 or 114 being used at a time of abnormality occurrence, the first and second pressure adjusting valves that are first and second micro-valves 124 or 126 can be protected.

Incidentally, pressure sensors for detection may be disposed between the respective opening and closing valves and the respective pressure adjusting valves. Further, it is possible to dispose a third auxiliary pressure adjusting valve in the piping route B connecting the auxiliary pressure valve for detection and the fuel battery cell to each other. Alternatively, the auxiliary pressure sensor for detection and the safety valve can be directly connected to each other.

Further, replacement of air (atmospheric air) in the fine fluid flow passage by hydrogen gas, such as by supplying hydrogen gas to the hydrogen storing alloy container, can be achieved by opening the opening and closing valve, the auxiliary valve, and the safety valve at a starting time of use.

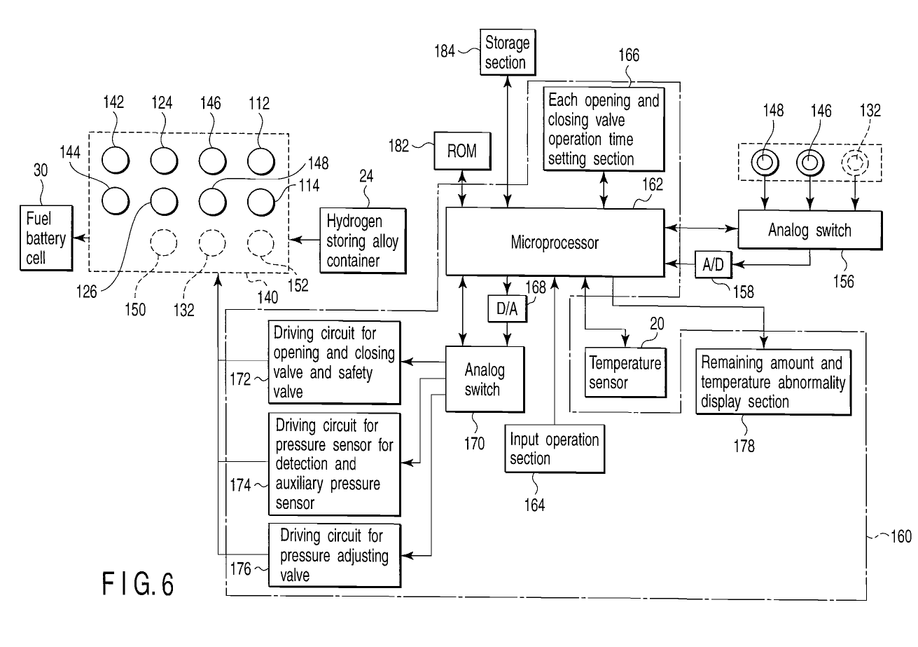

Next, a schematic configuration of a main portion of the control circuit in the fuel battery system will be explained with reference to a block diagram shown in FIG. 6.

In FIG. 6, a silicon substrate 140 is for connecting the hydrogen storing alloy container 24 and the fuel battery cell 30 to each other. The first and second opening and closing valves 112 and 114, first and second pressure sensors for detection 146 and 148, the first and second pressure adjusting valves 124 and 126, first and second safety valves 142 and 144, an auxiliary valve 152, an auxiliary pressure sensor for detection 136, and a safety valve 150 are disposed on the silicon substrate 140. The first and second pressure sensors for detection 146 and 148 and the auxiliary pressure sensor for detection 132 are connected to a microprocessor 162 via an analog switch 156 and an A/D converter 158.

The microprocessor 162 feeds control signals to respective driving circuits to provide a displacement amount of the pressure sensor or the pressure adjusting valve based upon outputs from the first and second pressure sensors for detection 146 and 148 and the auxiliary pressure sensor for detection 132. Incidentally, switching of the analog switch 156 is performed by an instruction from the microprocessor 162 according to the operation time setting (for example, setting for each 360 seconds) of each opening and closing valve.

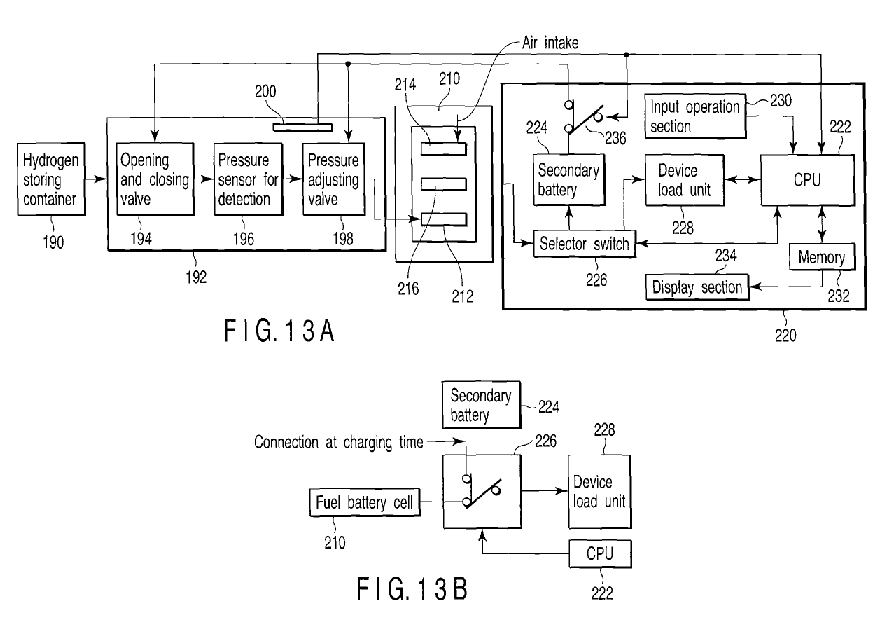

A battery system unit 160 is configured to include a microprocessor (the same as a CPU 222 in FIG. 13 described later, or one provided separately) 162, an input operation section 164, an each-opening and closing valve operation time setting section 166, a D/A converter 168, an analog switch 170, a driving circuit 172 for opening and closing valves and safety valves, a driving circuit 174 for a pressure sensor for detection and an auxiliary pressure sensor for detection, a pressure adjusting valve driving circuit 176, and a remaining amount and abnormality temperature (pressure) display section 178.

The microprocessor 162 is connected with a ROM 182 serving as storage means, a storage section 184, and the temperature sensor 20 described above. The ROM 182 stores table data values (table data values of hydrogen pressure—hydrogen remaining amount shown in FIGS. 4A and 4B, or FIG. 4 or FIG. 5 in Jpn. Pat. Appln. KOKAI Publication No. 2004-241261) therein. The storage section 184 stores reference data values for each unit (intra-pipe temperature limit valves or intra-pipe pressure limit values and remaining amounts of fuel depending on a vendor, kind or type of hydrogen storing alloy or the like) therein.

Incidentally, the microprocessor 162 incorporates each opening and closing valve operation time setting means (a timer or the like) for driving each opening and closing valve for a set time according to a predetermined program based upon a state of the input operation section 164 and an output of the temperature sensor 20.

The remaining amount and abnormality temperature (pressure) display section 178 is controlled by the microprocessor 162 and it is configured to include a display device for displaying kind of a battery or a vendor name, or the like. The remaining amount and temperature (pressure) abnormality display section 178 includes a plurality of LEDs for displaying a temperature (pressure) abnormality detection state. Alternatively, the remaining amount and abnormality temperature (pressure) display section 178 may display such a message as “battery remaining amount is insufficient. Please prepare for battery replacement” or “please reset fuel battery because of abnormality detection”.

Since the switch means for setting the kind of hydrogen gas for a fuel battery is provided in this manner, abnormality detection accuracy in the fuel battery system can be improved by using the intra-pipe temperature limit value or the intra-pipe pressure limit value depending on a vendor, kind or type of the hydrogen storing alloy, or the like.

With such a configuration, a set screen of the kind of battery in a power ON state is displayed. The microprocessor 162 detects key input from the input operation section 164 and kind of hydrogen storing alloy, a vendor, or a type designated from the input operation section 164. The microprocessor 162 reads a table data value showing correspondence with the kind or vendor of hydrogen storing alloy input from the ROM 182. A remaining amount of fuel together with a temperature in the fine fluid flow passage or a limit value of a pressure for detection is stored in the storage section 184. The microprocessor 162 causes the remaining amount and abnormality temperature (pressure) display section 178 to display the remaining amount of fuel.

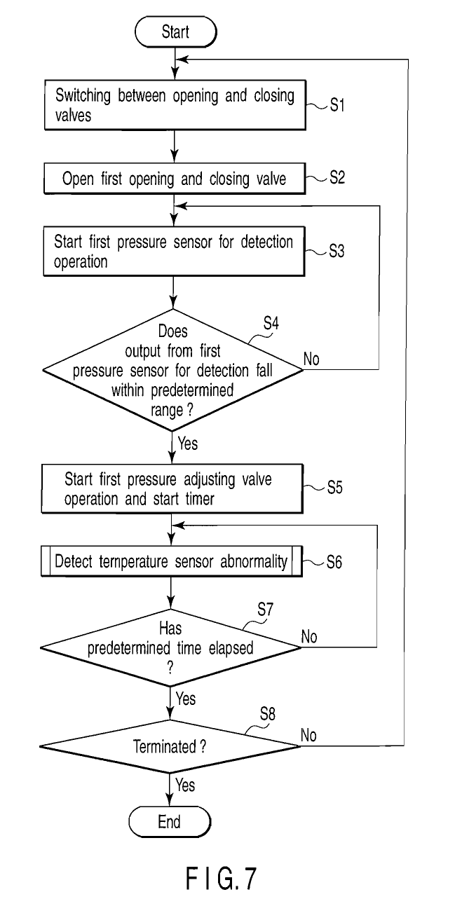

Next, an operation of the fuel battery system with this configuration will be explained with reference to a flowchart shown in FIG. 7.

The sequence is started and switching of the opening and closing valve is first performed at step S1. Next, when the first opening and closing valve 112 is opened at step S2, operation of the first pressure sensor for detection 146 is started at the next step S3. Determination is made at step S4 about whether or not a value obtained by the first pressure sensor for detection 146 falls in a predetermined range. Here, when the determination is negative, the control returns to the step S3, where the above processing operations are repeated. Meanwhile, when the determination is affirmative, or the value obtained by the first pressure sensor for detection 146 falls in the predetermined range, the control proceeds to step S5.

At step S5, an operation of the first pressure adjusting valve 124 is started and a timer (not shown) in the microprocessor 162 is started. At step S6, a subroutine “temperature sensor abnormality detection” is performed. A specific operation of the subroutine “temperature sensor abnormality detection” will be described later. Next, at step S7, determination is made about whether or not the time measured by the timer started at the step S5 reaches a predetermined time.

As a result, when the determination is negative, the control returns to the step S6, where the above processing operations are repeated. On the other hand, when the determination is affirmative, the control advances to step S8, where termination of the operation of the opening and closing valve (for example, the first or second opening and closing valve in the case of fine fluid flow passages of two systems, this step S8 can be also applied to four opening and closing valves in four systems, eight opening and closing valves in eight system, and the like) is determined. When the operation is not terminated, the control returns to the step S1, where the processing following the step S1 (for example, switching from the first opening and closing valve to the second opening and closing valve is performed, or switching from the second opening and closing valve to the first opening and closing valve) operation is repeated. On the other hand, the processing is terminated, the sequence is terminated.

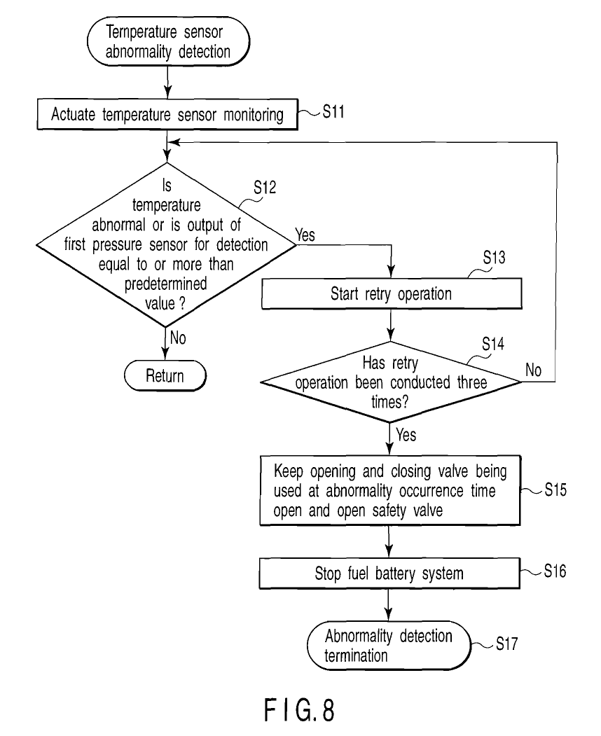

FIG. 8 is a flowchart for explaining a specific operation of the subroutine “temperature sensor abnormality detection” at the step S6 in the flowchart shown in FIG. 7.

When the control enters the sub-routine, the monitoring operation of the temperature sensor 20 is first started at step S11. Next, determination about whether or not temperature abnormality has occurred or an output of the first pressure sensor for detection 146 is equal to or more than a predetermined value is made at step S12 is made. Here, when the determination at step S12 is negative, the subroutine is normally terminated, the control exits from this subroutine to proceed to step S7 in the flowchart shown in FIG. 7. On the other hand, determination about whether or not a temperature abnormality has occurred or the first pressure sensor for detection 146 is equal to or more then a predetermined value is made, and the control proceeds to step S13.

A retry operation about these abnormalities is started at step S13. The number of retry operations is determined at step S14. In this case, for example, assuming that the number of retry operations is set to three, when the number of retry operations does not reach three, the control returns to step S12, where the abovementioned processing operation is repeated. Even if the number of retry operations reaches three, when the abnormality is detected, the control proceeds to step S15.

At the step S15, the opening and closing valve (the first opening and closing valve 112 in this case) being used at an abnormality occurrence time remains open and the safety valve 150 is opened. Next, the fuel battery system is stopped at step S16. Stopping of the fuel battery system is performed in the following manner.

A load connected to the fuel battery is disconnected to stop power generation using the switching of a booster DC/DC converter between a fuel battery cell and a device load unit (which are not shown). When power generation conducted by the fuel battery is stopped, switching from the fuel battery cell to the secondary battery is performed, and the switching is performed after a predetermined time elapses. That is, after power generation conducted by the fuel battery cell is stopped, the CPU switching connection of the output end of the fuel battery from the load to the secondary battery is carried out, so that it is made possible to charge the remaining power generated from hydrogen remaining in the fuel battery cell and air to the secondary battery, thus hydrogen remaining in the fuel battery cell is not required to be discharged outside. At this time, the charging is performed while maintaining a free capacitance equal to or more than a predetermined value in the secondary battery.

Thereafter, the control proceeds to step S17, where an abnormality termination processing is performed.

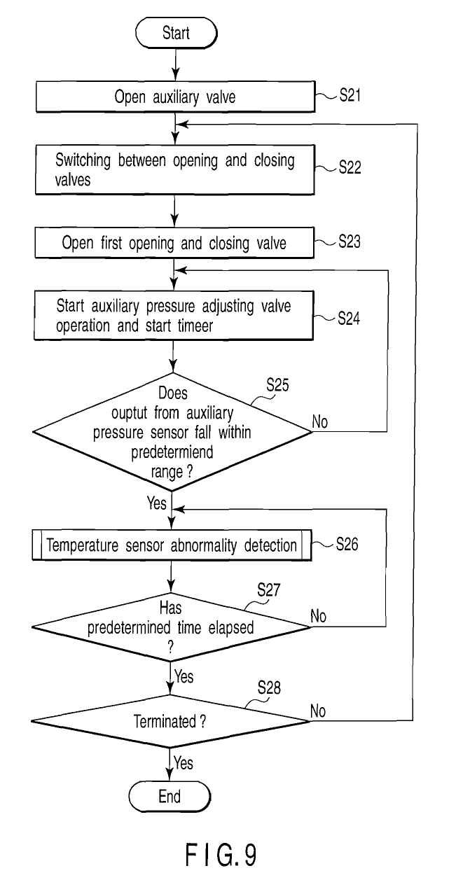

FIG. 9 is a flowchart for explaining an operation performed when the first and second pressure sensors for detection are removed from the fuel battery system with the abovementioned configuration, an auxiliary pressure sensor for detection is disposed between the auxiliary valve and the auxiliary pressure adjusting valve, and a safety valve is disposed at a position branched between the auxiliary pressure sensor for detection and the auxiliary pressure adjusting valve.

When the present sequence is started, the auxiliary valve 130 is first opened at step S21, and switching between the opening and closing valves is then performed at step S22. When the first opening and closing valve 112 is opened at step S23, an operation of the auxiliary pressure adjusting valve is started and a timer (not shown) in the microprocessor 162 is started at the next step S24. Determination about whether or not a value output from the auxiliary pressure sensor falls in a predetermined range is determined at step S25. Here, when the determination at step S25 is negative, the control returns to S24, where the abovementioned processing operation is repeated. On the other hand, when the determination is affirmative, the control proceeds to step S26.

The subroutine “temperature sensor abnormality detection” shown in FIG. 8 and described above is performed at step S26. Explanation about a specific operation of the subroutine “temperature sensor abnormality” is omitted. Next, at step S27, determination is made about whether or not the time measured by the timer started at the step S24 reaches a predetermined time. As a result, when the determination is negative, the control returns to the step S26, where the above processing operations are repeated. On the other hand, when the determination is affirmative, the control advances to step S28, where termination of the operation of the opening and closing valve (for example, the first or second opening and closing valve in the case of fine fluid flow passages of two systems, this step S28 can be also applied to four opening and closing valves in four systems, eight opening and closing valves in eight system, and the like) is determined. When the operation is not terminated, the control returns to the step S22, where the processing following the step S21 (for example, switching from the first opening and closing valve to the second opening and closing valve is performed, or switching from the second opening and closing valve to the first opening and closing valve) operation is repeated. On the other hand, the processing is terminated, the sequence is terminated.

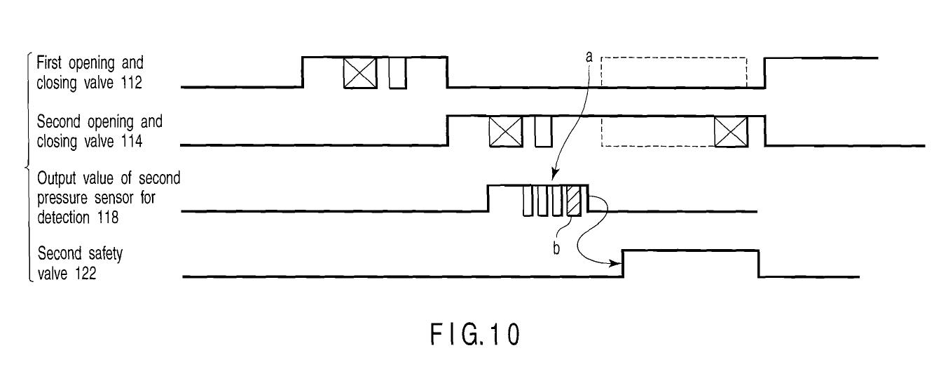

Next, an operation of the safety valve will be explained with reference to a timing chart shown in FIG. 10.

For example, such a case is assumed that an all-in-one fuel battery system including no fins manufactured by Company B is used and abnormality detection from the temperature sensor under operation of the second opening and closing valve 114 has occurred according to monitoring of a CPU in a mobile device. In the CPU, three retry operations are conducted for 60 seconds at a temperature of 53° C. (0.44 MPa) or more in illustration “a” and when a temperature 53° C. or more continues, temperature abnormality detection (illustration “b”) is determined.

Internal pressure is measured by the second pressure sensor for detection 118, and when the internal pressure is equal to or more than a predetermined value, the second safety valve 122 is opened so that hydrogen gas is discharged to the external air port. At this time, it is assumed that the second opening and closing valve 114 remains open. After a fixed time elapses, when an output from the second pressure sensor for detection 118 reaches a specified value or less, the second safety valve 122 is closed. A state that the second opening and closing valve 114 has been closed and the first opening and closing valve 112 has been opened is a restored state. By arranging a pressure sensor between the first opening and closing valve 112 and the first safety valve 120, pressure in the flow passage on the side of the first opening and closing valve 112 can be reduced.

Further, it is assumed that, when the first safety valve 120 is closed, temperature abnormality detection occurs at an operation time of the first pressure sensor for detection 116, and the first opening and closing valve 112 remains open. When an output signal from the first pressure sensor for detection 116 is in a desired range, the first safety valve 120 is closed. Alternatively, when a plurality of first and second opening and closing valves 112 and 114 are used on a silicon substrate in a combined manner, an average value of output signals from the first and second pressure sensors for detection 116 and 118 connected to the first and second opening and closing valves 112 and 114 is obtained, so that the safety valve is closed. As with Company C, such a configuration can be adopted that an output signal from one pressure sensor for detection is monitored and when the output signal is in a desired range, the first safety valve is closed.

Incidentally, as other means, such a configuration can be adopted that when a temperature abnormality occurs, the opening and closing valve is closed, and the safety valve is then opened, so that the continuous high pressure load applied to the pressure adjusting valve when the opening and closing valve is closed can be reduced in accordance with the power supply from the fuel battery cell to a device load or the second battery. Broken lines in FIG. 10 show normal states of the first and second opening and closing valves.

In the embodiment, a terminal plate disposed on a side face of the hydrogen storing alloy casing has eight signal wires and eight drive wires. The number of wires of these wires used in the second opening and closing valves can be selected according to the hydrogen storing alloy material or the like. The first opening and closing valve may be a known mechanical electromagnetic valve attached to the hydrogen storing alloy casing. Further, the second silicon substrate embedded with the temperature sensor and the HA chip for an amplitude signal amplifying circuit can be arranged on the first glass substrate other than the first silicon substrate or the second silicon substrate.

The temperature sensor and an acceleration sensor may be embedded in the second silicon substrate. It is especially effective to provide the acceleration sensor when a fluid level sensor is used for the remaining amount detection in such a case that the fluid level sensor is used in a fluid fuel battery because an error occurs in remaining amount measurement due to change in attitude of the fuel battery.

In the embodiment of the present invention, the hydrogen storing alloy container casing is used as the fuel, but a container casing of alcoholic fuel (for example, methanol) can be used. Such a case that air enters the fuel flow passage at a time of fuel tank replacement may occur. When air enters the fuel flow passage, output from the fuel battery cell lowers, so that the safety valve can be used as a purge valve for replacing air in the fuel flow passage by hydrogen gas after fuel replacement.

As described above, according to the fuel battery system, a volume can be reduced by providing a plurality of opening and closing valves, pressure sensors for detection, pressure adjusting valves and safety valves that are disposed in the piping route for supplying hydrogen from the hydrogen storing alloy container to the fuel battery cell on the silicon substrate on the glass substrate and disposing the glass substrate inside the hydrogen storing alloy container casing to unitize them. The load on the pressure adjusting valve can be reduced by driving the safety valve. As a result, a whole fuel battery system for a mobile device can be reduced in size.

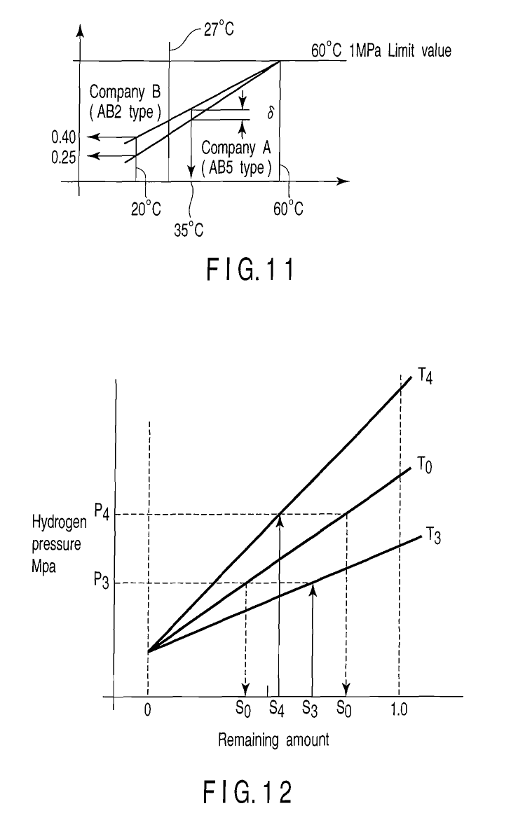

Next, referring to FIG. 11, the application voltage from the pressure sensor for detection to the pressure adjusting valve when various hydrogen storing alloys are used will be explained.

As shown in FIG. 11, LaNi₅ of the AB5 type or AB2 type alloy, which is the fuel storing alloy material, will be explained as an example. The temperature characteristics of these alloy materials differ due to differences between both the type of alloy manufactured, and the manufacturer. In the embodiment, an error value between the temperature characteristics (under the current use temperature of 35° C., for example, when temperature characteristics of hydrogen storing alloys produced by Company A and Company B differ, the value δ) can be corrected by determining a voltage applied to the pressure adjusting valve based upon the Table. (In this case, 0.25 MPa for the hydrogen storing alloy produced by Company A and 0.40 MPa for the hydrogen storing alloy produced by Company B at a temperature of 20° C. The limit values of the hydrogen storing alloys produced by Company A and Company B are both 1 MPa).

It is assumed that a pressure reference temperature for the remaining amount display is 27° C. For example, in a data or information processing device such as a single-lens reflex camera utilizing a fuel battery of hydrogen, methanol, or the like as a power source, a display illumination device utilizing an EL (electroluminescence) device or an LED (light emitting diode) consumes much power, which results in difficulty in use of illumination display control. Alternatively, when photographing is performed in a case of actual use of the camera including photographing preparation operation such as exchangeable lens attaching or detaching operation detection utilizing communication between an exchangeable lens and a camera main body (for example, a time of waiting for a shutter chance), an action against of intension of a user is caused, which results in such a problem that automatic management such as remaining amount display of a fuel battery or device-operable time display according to an attitude control completely depending on the digital camera side does not coincide with intension of a user.

From the above, a temperature at the current environment use time is set to 35° C. such that the temperature characteristics are not influenced at a remaining amount display time as much as possible.

Here, properties required for the hydrogen storing alloy material include rapid response and existence of hysteresis of a storing pressure and a discharge balance pressure, and an error generated due to a difference in material must be corrected. There is a temperature difference between a place where a temperature sensor is disposed and an internal pressure temperature in the piping route A from the hydrogen storing alloy casing, and an internal pressure temperature difference between the pressure sensors. It is difficult to measure a remaining amount and conduct display of the remaining amount according to usage of the electronic device in each case. An initial value is set to 20° C. and remaining amount display value can be obtained from a pressure sensor value of 27.5° C. (for example, an instruction from the CPU in a range of a predetermined group is 27° C.), which is an average temperature according to a PCT diagram, so that a remaining display error can be suppressed without being influenced by overpressure due to temperature change.

Here, a storage capacity for storing a pressure diagram for each of temperatures measured preliminarily can be reduced at a factory shipment time by utilizing an average value or grouping (a method for conducting plotting for each 2° C. to 3° C. in a temperature measurement range to determine measurement points in advance and regarding a range defined by an upper limit and a lower limit as measurement points). Alternatively, though not illustrated, even in such a case that such a pressure sensor in which a diaphragm is joined from plural pairs of driving electrode plates using an oscillator in a wall inside a hydrogen storing alloy container covered by a metal material is incorporated, there is a temperature difference between a position where a temperature sensor is disposed and the interior of the hydrogen storing alloy container. A pair of driving electrode plates inside the hydrogen storing alloy container can be disposed so as to be spaced from each other so that switching to a differential output signal can be performed when a remaining amount becomes small. Thus, since there are differences under environment, a temperature table of an average value of the current use environment temperature of 35° C. and a normal temperature of 20° C. used for the temperature characteristics is used.

In such a case that a remaining amount capacity is measured using a pair of driving electrode plates in a hydrogen storing alloy container, or a remaining hydrogen amount is measured using a known strain gauge (Jpn. Pat. Appln. KOKAI Publication No. Hei06-33787), secondary working is performed on the same container as a product in order to obtain a data characteristic table before shipping in advance and a thermo-module is attached to an outer peripheral face of the container because an output from a temperature sensor can change for each of 20° C., 23° C., 27° C., 30° C., 32° C., 35° C., 40° C., and 45° C. A valve of the hydrogen storing alloy container is opened, a discharge hydrogen amount for each temperature is obtained by a hydrogen flow meter, and a remaining hydrogen amount is obtained via an amplitude voltage circuit from a pair of corresponding driving electrode plates. That is, in a configuration of the fuel battery shown in FIG. 3A, a relationship of a total consumption time of a fuel battery for each discharge hydrogen amount is obtained in a configuration of the fuel battery shown in FIG. 3A.

The remaining amount display is conducted as a remaining amount time or a percentage display (remaining amount time/total consumption time), and the remaining amount time can be obtained by reducing accumulation of the number of times of use of the pressure adjusting valve and the safety valve and a use time thereof from a total consumption time. A PCT coefficient for each temperature is determined and correlation (weighting) is determined in advance. Data (Tables shown in FIGS. 10A and 10B) obtained here is stored in the ROM 182. A program for write and read of data stored in the storage section 184 is stored in the ROM 182. By adopting such a configuration, a remaining amount detection sensor provided in the hydrogen storing alloy container can be omitted.

By disposing a thermo-module (for example, peltiert device) wiring board in a recessed face of an outer face of a hydrogen storing alloy container made from a metal material such as stainless steel, control can be performed by the CPU such that a temperature reaches 20° C. (ordinary temperature). As a result, an output signal from the pressure sensor for detection can be stabilized. Accordingly, only data close to the ordinary temperature (20° C.) needs to be stored. Therefore, a storage capacity of a memory (for example, a ROM or the like) can be reduced largely.

Here, the PCT coefficient will be explained.

In order to make a temperature difference correlation between a temperature at a place where a temperature sensor is disposed within an electronic device and a temperature inside a hydrogen pipe within a silicon substrate in a fuel battery system, an accurate remaining amount can be displayed using the PCT coefficient without detecting an over-large or over-small remaining amount.

When such a temperature sensor as a thermistor that converts a temperature used in a fuel battery cell or a secondary battery unit to an electric resistance is used, a temperature of the secondary battery detected by a temperature detecting section and exposed to a surface of the fuel battery cell or the secondary battery unit is output to an arithmetic section for a PCT coefficient in the microprocessor in order to conduct remaining amount display via the A/D converter converting analog signal to digital signal. The temperature sensor detects a temperature of the fuel battery cell or the secondary battery at a sampling cycle of several times per each predetermined time period to output the detected temperatures of the fuel battery cell or the secondary battery to the arithmetic section for a PCT coefficient. In the arithmetic section for a PCT coefficient, calculation of the PCT coefficient is performed to make a correlation between a location of the temperature sensor used in the electronic device and an intra-pipe temperature in the fuel battery.

FIG. 12 is a pressure-remaining amount diagram for a plurality of temperature characteristics. From FIG. 12, conversion to a table T₀ temperature for remaining amount display using a PCT coefficient δ_{PCT} will be explained. Incidentally, a remaining amount of a fuel battery for an actually measured temperature is shown by a solid line while a remaining amount of the fuel battery inside a hydrogen gas flow passage is shown by a broken line.

Here, for example, with a hydrogen pressure value P₄ MPa at a temperature (30° C.) of the fuel battery cell or a temperature T₄ (30° C.) of the secondary battery, a structure inside a camera for each type is actually measured in advance in order to obtain a temperature T₀ inside a hydrogen pipe provided with a pressure sensor for detection inside a fuel battery. Here, for example, when a temperature T₀ inside the hydrogen pipe is 27° C., the PCT coefficient δ_{PCT}=T₀−T₄ is obtained.

By performing calculation of the PCT coefficient according to a temperature difference in this manner, even if a temperature sensor is not incorporated in the fuel battery unit, a temperature inside a hydrogen pipe can be obtained. When a temperature of the fuel battery cell or a temperature of the secondary battery is raised to 33° C. or T4 (33° C.), the temperature inside the hydrogen pipe becomes T0 (30° C.), so that the PCT coefficient δ_{PCT} equals a difference of 3° C.

Similarly, when a temperature detecting section is disposed inside a camera module unit such as a single-lens reflex camera like the present embodiment, the PCT coefficient can be used. Alternatively, the PCT coefficient can be used for a digital camera that includes a water pressure and temperature (with conversion to moisture) section (not shown) that detects a water depth and water pressure/moisture and is exposed to a surface of a digital camera and that can perform retrieval based upon position information such as the abovementioned data from an album obtained by photographing, or the like.

Alternatively, specifically, the PCT coefficient can be utilized in a digital camera provided with a mechanism and a driving circuit for opening and closing a cover for protecting a lens for a camera under such an environment condition as a low ambient temperature. In the case of a water-proof digital camera for performing photographing underwater, the PCT coefficient can be determined with a hydrogen pressure value P_{S} MPa at a surface temperature of T₃ (10° C. to 20° C.) or for each utilization environment condition, such as a case of use in the mountains, where barometric pressure changes widely.

In a case of a digital camera for outdoor photographing, even if a digital camera is utilized with a surface temperature of T1 (35° C.), correction data (not shown) for correcting for an outside atmospheric pressure is stored in the memory. Alternatively, such a configuration may be adopted that remaining amount display is stopped on a high mountain or in water and, for example, a warning display “during remaining display off” is performed on a display screen.

When a temperature T₀ (27° C.) inside a hydrogen pipe provided with a pressure sensor for detection within a fuel battery is selected, PCT coefficient δ_{PCT}=T₀−T₁ is obtained.

By performing such calculation of the PCT coefficient, even if a temperature sensor is not incorporated in the fuel battery unit, a temperature difference inside the hydrogen pipe can be obtained.

Further, when a temperature inside the camera module unit is set to T₂ (25° C.) and a temperature T₀ (27° C.) inside the hydrogen pipe provided with a pressure sensor for detection within the fuel battery is selected, a PCT coefficient δ_{PCT}=T₀−T₂ is obtained.

By selecting a desired one of temperature sensors disposed in respective portions in this manner and performing each of the PCT coefficients, even if a temperature sensor is not incorporated in the fuel battery unit, a temperature within the hydrogen pipe can be obtained.

As another method, such replacement that a room temperature inside a battery accommodating chamber is measured by a thermistor attached in the battery accommodating chamber inside the electronic device and a temperature inside the hydrogen pipe is obtained from a temperature difference between a temperature of the battery accommodating chamber and a temperature inside a hydrogen flow passage on the silicon substrate, namely, the PCT coefficient can be adopted.

Next, referring to FIGS. 13A and 13B, a combination of the fuel battery system and remaining amount display of an electronic device incorporated with the secondary battery or the CPU will be explained.

The hydrogen storing alloy casing includes a hydrogen storing alloy container 190, an opening and closing valve 194, a pressure sensor for detection 196, and a pressure adjusting valve 198 that are disposed on a silicon substrate 192, and a temperature sensor 200. A fuel battery cell 210 comprises an anode electrode 212, a cathode electrode 214, and a polymer solid electrolytic film 216. A mobile electronic device placement unit (for example, a cradle apparatus, a Printer Dock (a product name of KODAK Corporation), or a projector placement stand) 220 is provided with a control circuit (CPU) 222, a secondary charger (secondary battery) 224 for initially driving the abovementioned opening and closing valve 194, pressure sensor for detection 196, and pressure adjusting valve 198, a current detector (device load unit (except for a battery)) 228 for detecting a remaining amount of the secondary battery 224, a selector switch 226, a memory 232 in which data (Tables in FIGS. 4A and 4B) related to temperature change is stored, and an input operation section 230 comprising a display portion 234 for performing remaining amount display of a fuel battery and an input key for user operation.

The temperature within a piping route (for example, 27° C. or 15° C.) is set to a measurement environment temperature for each fuel battery for each kind or each date of manufacture, and the battery life of a battery is measured in accordance with the following conditions before factory shipment so that the number of times of photographing and the number of times of strobe light emission for each hydrogen fuel battery are stored in the memory 232 (a threshold of ⅕ to 1/10 is actually used).

(1) A liquid crystal display monitor is always turned ON.

(2) Photographing at a telescopic end and photographing at a wide-angle end are alternately performed by an optical zooming mechanism for each 30 seconds.

(3) Strobe light emission is performed with full light emission at least one of two times.

(4) ON/OFF operation of a power source is performed for each 10 photographing operations.

Photographing operations are continued under the abovementioned conditions (1) to (4). Measurement is terminated at a time at which a power source is first shut down or photographing cannot be conducted. A measurement time and the total number of times of operation in each operation are stored in the memory 232. Regarding the stored measurement time and total number of times of operation in each operation, especially, when the remaining amount of the fuel battery exceeds a threshold of ⅕ to 1/10, for example, a message “remaining amount is insufficient” is output on a display screen as the remaining amount display. Simultaneously therewith, when switching of arithmetic operation is performed from the remaining amount display of the fuel battery to the memory in which the total time and the required number of times of each operation corresponding to the remaining amount of ⅕ to 1/10 are stored, switching to display of a possible number of times of photographing, a possible number of times of strobe light emission of the remaining amount, or the like can be performed. The number of times of each operation used by a user is subtracted and the remaining number of times of each operation is updated when sampling is performed for each predetermined time in an operating state of a camera, when power is off, or the like.

With such a configuration, convenience for a user is improved.

In addition thereto, medical equipment has been disclosed in FIG. 1 in Jpn. Pat. Appln. KOKAI Publication No. 2003-210395, for example. In the Publication, a capsule type medical equipment of a capsule type endoscope where a switch for a power source or the like can be turned ON and OFF is shown. There is an intra-body unit provided with, for example, a temperature sensor exposed to a surface, an antenna unit, a power source (fuel battery) for a body unit, image display, an operation button, a control circuit, a memory, and the like, for receiving, for example, a signal of an image that is photographed by a capsule endoscope such as shown in FIG. 1 and is transmitted from an antenna incorporated in the capsule type endoscope. The fuel battery system can be used in such an intra-body unit.

Incidentally, for example, an intermediate repeater may be used for the capsule type medical equipment.

Referring to FIG. 13A again, a piping route from the pressure adjusting valve 198 is connected to the anode electrode 212. The CPU (control circuit) 222 monitors an output signal from the temperature sensor 200 embedded in the silicon substrate 192. The CPU 222 monitors the remaining amount display of the fuel battery cell 210 or a current value in the device load unit 228. Further, the CPU 222 can detect the remaining amount from an output signal from the device load unit 228 by the selector switch (SW) 226 when the fuel battery cell 210 is connected to the electronic device 220.

However, by disregarding remaining amount detection, an output signal from the pressure sensor for detection 196 and an output signal from the temperature sensor 200 are prioritized and are displayed on a display section (display) 234 utilizing a remaining amount calculation value of data (Tables shown in FIGS. 4A and 4B) from kind and temperature characteristics of the hydrogen storing alloy container of Company B designated by a user, namely, the hydrogen storing alloy container of AB5 type, stored in the memory 232. Thereby, the user can confirm the remaining amount calculation value.

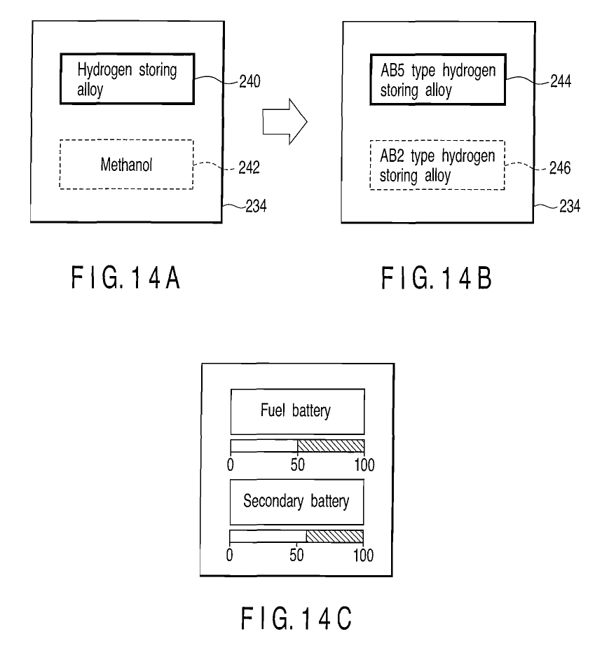

For example, in an example shown in FIG. 14A, hydrogen storing alloy 240 and methanol 242 are displayed on the display section 234. However, according to the user's operation at the input operation section 230, one of AB type hydrogen alloy 244 and AB2 type hydrogen alloy 246 can be selected and displayed, as shown in FIG. 14B. Further, as shown in FIG. 14C, it is possible to conduct remaining amount display for each of usable batteries when secondary batteries, fuel batteries (including those using various hydrogen storing alloys) or combinations of these batteries are used. In this case, remaining amount display is conducted regarding batteries being used but remaining amount display disappears regarding unused batteries.

At an actuation time when an operation starting signal of the device load unit 228 is input, the CPU 222 closes the switch 236 to actuate the secondary battery 224. That is, as shown in FIG. 13B, connection from the fuel battery cell 210 to the secondary battery 224 is performed at a charging time by the selector switch 226. In the cradle, which is a mobile device, when a device load unit (for example, an electronic camera or the like) 228 is mounted on the cradle and the fuel battery cell 210 is operated, the CPU 222 operates the selector switch 226 so that the secondary battery 224 halts. Control of the pressure adjusting valve 198 or the fuel battery cell 210 is put in an operating state so that the device load unit 228 operates. At such a time, such a merit can be obtained that the CPU 222 can be utilized by using only the fuel battery cell 210 or using both the fuel battery cell 210 and the secondary battery cell 224 even outdoors, where no outlet is provided.

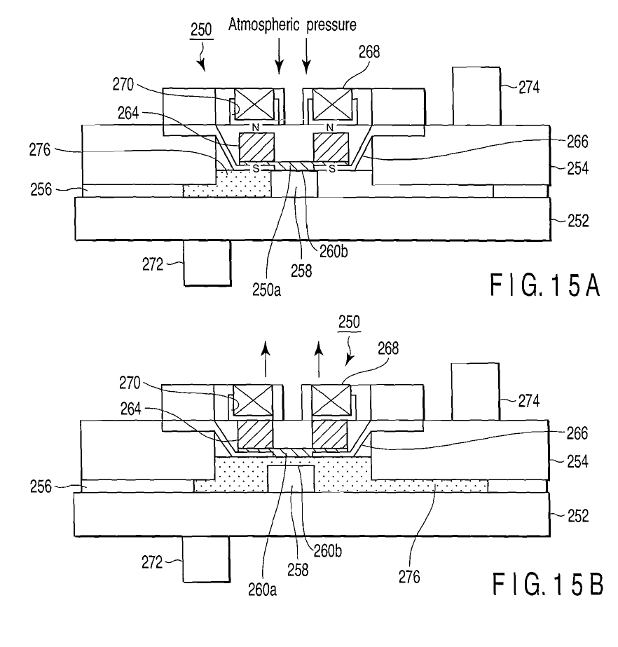

Next, referring to FIGS. 15A, 15B to FIGS. 17A, 17B, structures of the safety valve and the opening and closing valve in the first embodiment of the present invention will be explained.

FIGS. 15A and 15B are sectional views showing one example of a fuel battery system configured with a safety valve with an electromagnetic actuator, FIG. 15A showing a state that the safety valve has been closed, while FIG. 15B showing a state that the safety valve has been opened.

In a safety valve 250, a second silicon substrate 254 is disposed on a first silicon substrate 252 and a flow passage 256 is provided between both the substrates. A valve seat receiving plate 258 coated with a second magnetic layer 260b different from a first magnetic layer 260a described later is disposed on an upper surface of the first silicon substrate 252. On the other hand, a diaphragm 266 including a ring-like magnet layer 264 on its upper face is formed on a lower layer of the second silicon substrate 254.

Further, a driving coil layer 268 is disposed on an upper layer of the second silicon substrate 254 so as to be opposed to the magnet layer 264, which is enabled through fine machining. A coil protective layer 270 serving as a protective film is provided on the driving coil layer 268. A circular or rectangular through-hole is formed at a central portion of the diaphragm 266. The first magnetic layer 260 is joined to an S polar face of the magnetic layer 264, and the first magnetic layer 260a is caused to project into the through-hole of the diaphragm 266.

Incidentally, as surfaces of the magnet layer 264 and the diaphragm 266 are pressed by atmospheric pressure, and a through-hole is provided at a central portion of the driving coil layer 268.

A piping route A272 and a piping route B274 are provided in the first silicon substrate 252 and the second silicon substrate 254, respectively.

Regarding the safety valve 250 thus configured, a state where the driving coil is not energized will be explained.

Attraction takes place between the magnet layer 264 of the diaphragm 266 on the second silicon substrate 254 and the valve seat receiving plate 258 having the second magnetic layer 260b of the first silicon substrate 252. Accordingly, the safety valve 250 has been closed in this state. Therefore, hydrogen 276 in the flow passage 256 stays in the flow passage 256 on the side of the piping route A272 (see FIG. 15A).

A relationship between the magnet layer 264 disposed on the diaphragm 266 and the second magnetic layer 260b made from a soft iron alloy or the like enable the magnet layer 264 and the second magnetic layer 260b to attract each other due to magnetic flux emanating from the S layer of the magnet layer made from the alloy material (for example, samarium-cobalt alloy) including a rare-earth element magnetized in a thickness direction.

When a driving current for the driving coil layer 268 is shut off, hydrogen to the piping route B274 can be shut off reliably.

Next, a state that the driving coil layer 268 has been energized will be explained.

When the driving coil layer 268 is energized, an attraction force between the magnet layer 264 and the driving coil layer 268 is generated. Thereby, when an attracting force increases between the valve seat receiving plate 258 having the second magnetic layer 260b of the first silicon substrate 256 and the magnet layer 264, the diaphragm 266 is raised. Accordingly, the safety valve 250 is opened (see FIG. 15B). Here, the second magnetic layer 260b and the magnet layer 264 may be replaced by a ring-like or a rectangular permanent magnet with an N pole and an S pole magnetized in a thickness direction thereof.

Incidentally, the safety valve 250 has been explained here, but the opening and closing valve can be configured in the same manner as the safety valve 250.

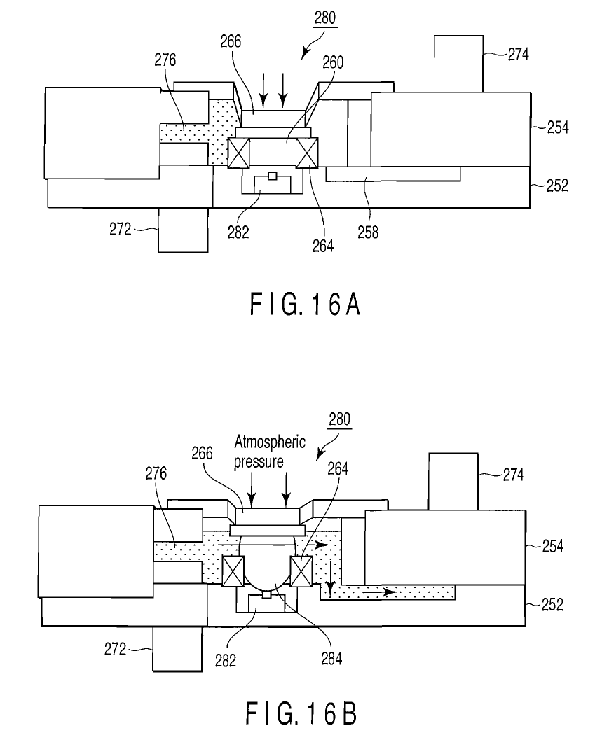

FIGS. 16A and 16B are sectional views showing one example of a fuel battery system comprising an opening and closing valve and a heat generator actuator, FIG. 16A showing a state that the opening and closing valve has been closed, while FIG. 16B showing a state that the opening and closing valve has been opened.

In an opening and closing valve 280, a second silicon substrate 254 is disposed on a first silicon substrate 252 and a flow passage 256 is provided between both the substrates. A heat generator 282 is disposed in a recessed portion on an upper surface of the first silicon substrate 252, and a ring-like magnet layer 264 is disposed around the heat generator 282. On the other hand, a magnetic layer 260 is formed on a lower portion of a diaphragm 266 provided on the second silicon substrate 252. The diaphragm 266 is pressed downwardly (on the side of the heat generator 282 of the first silicon substrate 252) by atmospheric pressure and the attraction force between the magnet layer 264 on the first silicon substrate 252 and the magnetic layer 260 of the diaphragm 266.

A piping route A272 and a piping route B274 are provided in the first silicon substrate 252 and the second silicon substrate 254, respectively.

In the opening and closing valve 280 thus configured, the diaphragm 266 is first pressed downwardly (on the side of the heat generator 282 of the first silicon substrate 252) in a state that a pulse driving voltage has not been applied to the heat generator device by atmospheric pressure and the attraction force between the magnet layer 264 on the first silicon substrate 252 and the magnetic layer 260 of the diaphragm 266. Accordingly, in this state, hydrogen 276 stays in the flow passage 256 on the piping route A272 (see FIG. 16A).

Next, when a pulse driving voltage is applied to the heat generator 282, bubbles 284 occur on a surface of the heat generator element. When the bubbles 284 expand, the bubbles 284 become large due to the attraction force between the magnet layer 264 and the magnetic layer 260 of the diaphragm 266 so that the diaphragm 266 is moved upwardly. Accordingly, the valve is put in an open state (see FIG. 16B).

When application of the pulse driving voltage to the heat generator element is stopped, the bubbles 284 deflate. Thereby, the attraction force between the magnet layer 264 provided on the first silicon substrate 252 and the magnetic layer 260 of the diaphragm 266 becomes large, so that the diaphragm 266 returns back to its original or home position and the valve is closed (see FIG. 16A).

Incidentally, the opening and closing valve has been explained here, but the safety valve can be configured in the same manner as the opening and closing valve.

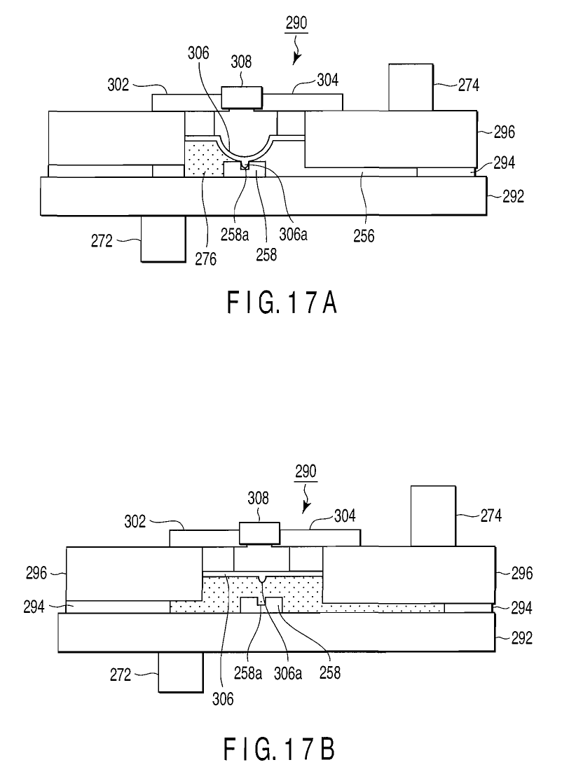

FIGS. 17A and 17B are sectional views showing one example of a fuel battery system where an opening and closing valve is made from a shape-memory alloy material, FIG. 17A showing a state that the opening and closing valve has been closed, while FIG. 17B showing a state that the opening and closing valve has been opened.

In an opening and closing valve 290, a first silicon substrate 294 and a second silicon substrate 296 are disposed on a glass substrate 292, and a flow passage 298 is provided between the first silicon substrate 294 and the second silicon substrate 296. A valve seat receiving plate 258 is disposed on an upper surface of the glass substrate 292. A diaphragm 306 made from a shape-memory alloy material with a martensitic phase and obtained by laminating a negative electrode 302 and a positive electrode 304 is provided on an upper layer of the second silicon substrate 296. Further, an insulating plate 308 is provided between the negative electrode 302 and the positive electrode 304.

The valve seat receiving plate 258 formed on the glass substrate 292 is formed in a parallelepiped shape and is formed at a central portion with a recessed portion 258a. The recessed portion 258a of the parallelepiped part and a projecting portion 306a on the shape-memory alloy (diaphragm) 306 are fitted to each other.

Further, a piping route A272 and a piping route B274 are provided in the glass substrate 292 and the second silicon substrate 296, respectively.

In the opening and closing valve 290 thus configured, the diaphragm 306 becomes concave, projecting toward the flow passage 256 and the projecting portion 306a formed at the central portion of the diaphragm 306 is fitted into the recessed portion 258 on the valve seat receiving plate 258 in a non-energized state. Therefore, hydrogen 276 is banked up by the diaphragm 306, so that it stays in the flow passage 256 on the side of the piping route A272 (see FIG. 17A).

When a current is supplied via the positive electrode 304 and the negative electrode 302 in an energized state, the diaphragm 306 generates heat, which results in a rise in temperature. Thereby, the shape-memory alloy phase-changes to become flat so that the opening and closing valve is put in an open state (see FIG. 17B).

Incidentally, the opening and closing valve has been explained here, but the safety valve can be configured in the same manner as the opening and closing valve.

The shapes of the safety valve and the opening and closing valve described above are not limited to ones shown in FIGS. 15A, 15B to FIGS. 17A, 17B.

### Second Embodiment

Next, a second embodiment of the present invention will be explained.

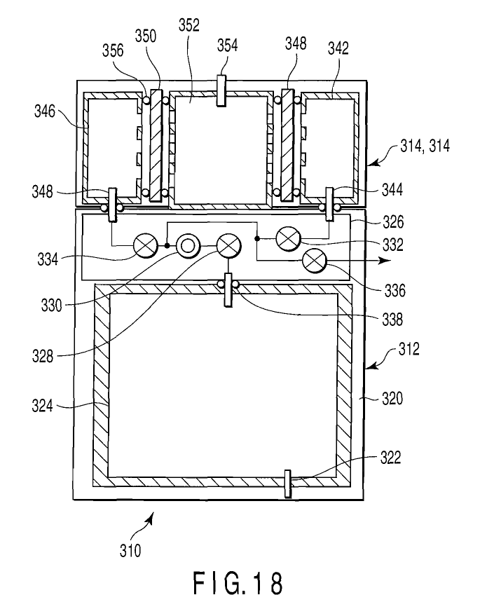

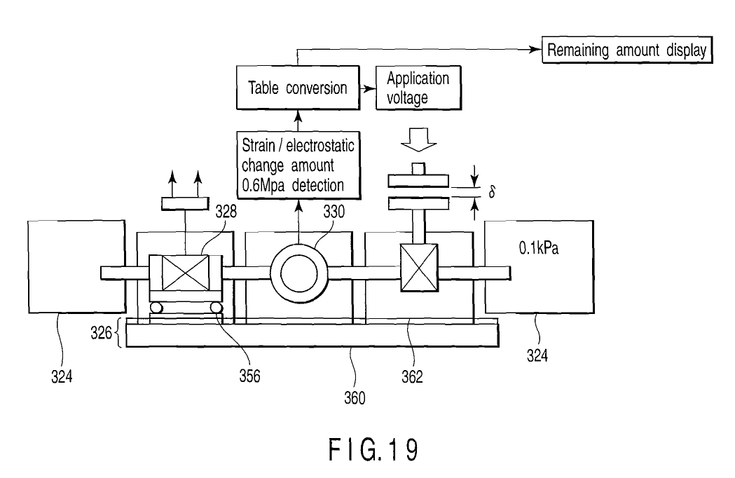

FIG. 18 is a diagram showing a configuration of a fuel battery system according to a second embodiment of the present invention, and FIG. 19 is a diagram for explaining an operation of the fuel battery system with the configuration shown in FIG. 18.

A fuel battery system 310 according to the second embodiment has such a configuration that a hydrogen storing alloy container 312 and two fuel battery cells 314 and 314 have been unitized.

Specifically, a casing 320 includes a fuel tank container 324, which is a hydrogen storing alloy container, and has a hydrogen supplying port 322, and an opening and closing valve 328, a pressure sensor for detection 330, first and second pressure adjusting valves 332 and 334, and a safety valve 336 that are disposed on a semiconductor substrate 326. The fuel tank container 324 and the opening and closing valve 328 are connected to a piping route A338. A piping route B1344 connecting the first pressure adjusting valve 332 and a first anode electrode 342 is provided on the side of the fuel battery cell 314. Similarly, a piping route B2348 connecting the second pressure adjusting valve 334 and a second anode electrode 346 is provided.

The fuel battery cell 314, 314 comprises the abovementioned first and second anode electrodes 342 and 346, first and second polymer fixed electrolytic films 348 and 350, a cathode electrode 352, and a catalyst. An air chamber constituting two cathode electrodes is disposed at a central portion of the fuel battery cell 314, 314. The air chamber is supplied with air from an air intake port 354.

The first and second polymer fixed electrolytic films 348 and 350 are held between the cathode electrode and the anode electrode by a plurality of elastic members comprising O-rings 356, respectively. The first and second polymer fixed electrolytic films 348 and 350 are sealed by the O-rings 356. Incidentally, reference numeral 360 denotes a glass substrate and reference numeral 362 denotes a first silicon substrate, the substrates constituting the abovementioned semiconductor substrate 326.

In an operation of the fuel battery system 310 with such a configuration, when a switch of an operation button of a mobile device (not shown) is turned ON, the secondary battery is actuated and the opening and closing valve 328 is opened so that hydrogen gas is replenished to the side of the first anode electrode 342 and the second anode electrode 346. Next, detection about whether or not an output from the pressure sensor for detection 330 has reached a desired pressure valve is made. Control of the first and second pressure adjusting valves 332 and 334 are started based upon memory data (shown in Tables in FIGS. 4A and 4B and in FIG. 19) from the detected pressure value.

The air chamber on the side of the cathode electrode 352 is always supplied with air from the air intake port 354. This configuration is configured such that each fuel battery cell 314, 314 is supplied with hydrogen gas from the fuel tank container 324 and external air so that power generated in the fuel battery cell is supplied from an electrode (not shown) to the device load unit and the display device.

In FIG. 19, the glass substrate 360 and the first silicon substrate 362 on the glass substrate 360 are formed between the hydrogen storing alloy container 324 with an internal pressure of 0.92 kPa (53° C. or lower) and the fuel battery cell 314 with a mechanical strength of 0.1 MPa internal pressure of polymer fixed electrolytic films. The opening and closing valve 328, the pressure sensor for detection 330 for measuring pressure of hydrogen from the opening and closing valve 328, and the pressure adjusting valve 332 (334) for reducing the pressure of hydrogen gas from the opening and closing valve 328 are provided on the first silicon substrate 362 in this order from the side of the hydrogen storing alloy container 324 formed by a MEMS microfabrication technique. The pressure adjusting valve 332 (334) is controlled so as to conduct pressure reduction to 1/9 (when n pressure adjusting valves are disposed, pressure reduction is n/9) in a running operation time. At this time, a change amount δ (for example, change in capacitance of a piezoelectric body) of the pressure adjusting valve is applied to both the electrodes based upon Table shown in FIG. 4A.

A thickness of the opening and closing valve 328 is adjusted such that a thermally-deformable conductive material (not shown) which is thermally deformed changes according to a known hydrogen pressure on the side of the fuel battery cell 314. The force acting from the above on the diaphragm formed with thermally-deformable material where an insulating film is disposed between both the electrodes is reduced by control of the opening and closing valve 328 and reduction of an area of the diaphragm receiving pressure from the side of the hydrogen storing alloy container 324. That is, such a configuration is adopted that the opening and closing valve 328 is pressed upwardly by the O-ring 356 made from an elastic material and disposed under the opening and closing valve 328. When a voltage is applied to the thermally-deformable material, the diaphragm is deformed so as to overcome the pressing force of the O-ring 356 so that the piping route feeding hydrogen from the hydrogen storing alloy container 324 and the piping route feeding hydrogen to the pressure adjusting valve are caused to communicate with each other.

The pressure sensor for detection 330 is formed by a microfabrication technique such as insulation film formation and etching such that a diaphragm joined to a known strain-deformable material is positioned on the side of an upper face. Alternatively, an electrostatic substrate may be joined to the diaphragm. A cavity portion is formed between the diaphragm and the first silicon substrate 362 forming a flow passage on the under side thereof.

As another modification, a temperature sensor can be disposed on a surface inside a cavity portion on a surface of the first silicon substrate in the pressure sensor of the present invention. With such a configuration, a gas temperature can be measured directly and the PCT coefficient (which is determined as 1.0 under such a condition that an output temperature from the temperature sensor is 60° C. and a pressure is 1 MPa) can be simplified without generating strain of the diaphragm due to the temperature sensor or including an error due to positional deviation of a place where the temperature sensor is disposed.

A function operating equation for conducting conversion to a flow rate of gas from the pressure adjusting valve which is obtained pressure difference measurement for each temperature between the cavity portion of the pressure sensor and the pressure adjusting valve before factory shipment can be stored in the ROM.

### Third Embodiment

Next, a third embodiment of the present invention will be explained.

The third embodiment has a configuration obtained by modifying the fuel battery system in the abovementioned first embodiment shown FIG. 3B, and it is an embodiment regarding a fuel battery system provided with a plurality of fuel tanks and a plurality of fuel batteries.

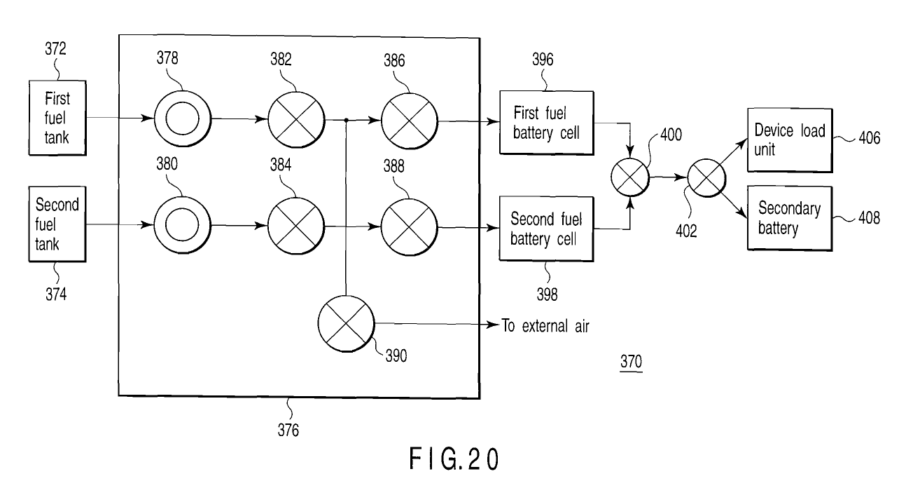

FIG. 20 is a block diagram showing a configuration of the fuel battery system according to the third embodiment of the present invention.

In a fuel battery system 370, first and second pressure sensors for detection 378 and 380 and first and second opening and closing valves 382 and 384 are arranged in parallel on a silicon substrate 376 from first and second fuel tanks (hydrogen storing alloy containers) 372 and 374 different in hydrogen storing alloy via respective piping routes (not shown). A safety valve 390 is disposed between the first and second opening and closing valves 382 and 384 and external air. First and second pressure adjusting valves 386 and 388 are disposed between the first and second opening and closing valves 382 and 384 and the first and second fuel battery cells 396 and 398, respectively.

First and second selector switches 400 and 402 are arranged in series between the first and second fuel battery cells 396 and 398, and device load unit 406 and a secondary battery 408.

The first and second fuel battery cells 396 and 398 and the first and second selector switches 400 and 402 operate in the following manner.

Battery specification conditions of the device load unit (the number of photographs acquired at a photographing time, the limit of a moving image time, the time limit of a slide show during playback, and the like) 406 can be changed according to selection of either of the first fuel battery cell 396 and the second fuel battery cell 398.

As another specific example, in a disc/video camera recording moving image or still image data photographed in a user area in a disc (an optical disc; for example, phase-change type recording medium, vertical magnetization amorphous recording medium) like recording medium made from a vertical magnetization recording material or phase-change recording material, a disc/video camera can utilize one provided with temperature detecting means for detecting a temperature from a temperature sensor incorporated in an access mechanism driving system for causing a semiconductor laser of a head portion incorporated in a disc device or a head to conduct a seek action in a radial direction, or a temperature sensor disposed near a disc-like recording medium.

In this case, a second selector switch 216 is arranged in parallel between the first and second fuel battery cells 396 and 398, and a device load unit 406 and a secondary battery 408 (a first selector switch for selecting one of the first fuel battery cell 396 and the second fuel battery cell 398 is not disposed).

In a fuel battery system including first and second fuel battery cells, a package including a set of fuel tanks (hydrogen storing alloy containers) that supplies fuel to the fuel battery cells and a cooling device having an area smaller than an area of a back face of the fuel tank is disposed near the fuel tank. In an imaging device, control is performed so as to actuate the cooling device at an actuation time when an imaging element (for example, a CCD or a CMOS) shoots a subject.

Alternatively, in a device load unit comprising a temperature sensor measuring a surface temperature of an IC chip for a lens driving circuit, control is performed according to a measurement result of the temperature sensor by a circuit for controlling an operation of a pair of fuel battery cells. When a surface temperature of the IC chip for a lens driving circuit reaches a predetermined temperature, the control circuit conducts control so as to start power supply to the cooling device or lower an amount of power supplying to the fuel battery cell.

Further, the fuel battery can be cooled by the cooling device in a time period from start of the imaging operation conducted by the control circuit to transfer of a still image from the imaging device to the disc device. In such a case, configuration is made so as to drive the imaging device by the first fuel battery cell to drive a disc device and a buffer memory utilizing the second fuel battery cell. Simultaneous operation is performed without halting the first and second fuel battery cells.

When a remaining amount of the first fuel tank connected to the first fuel battery cell reaches a limit value for driving the imaging device from this state, switching is performed such that the imaging device, the disc device and the buffer memory are driven by the second fuel battery cell.

When a remaining amount of the second fuel tank connected to the second fuel battery cell reaches a limit value required for driving the disc device and the buffer memory, switching is performed such that the imaging device, the disc device, and the buffer memory are driven by the first fuel battery cell.

Accordingly, such a configuration can be adopted that, when a user uses the imaging device, warning display is performed on a display device (LCD), a light emitting diode (LED) is lit, or/and a warning message sound or warning message is issued such that the user can understand a state of the first or the second fuel battery cell (using state of both the fuel battery cells or using state of either of the fuel battery cells). Thereby, without halting the disc device, the CPU can detect an output from the pressure sensor within the fine fluid flow passage pipe using a temperature sensor or the like disposed near a disc inside the disc device to activate the first and second fuel battery cells, thereby driving the imaging device.

In battery remaining amount warning display, such a problem that a usable time under a low temperature environment is shorter than that under a normal temperature environment occurs. Therefore, the temperature sensor detecting a temperature is provided so as to be exposed on an exterior of the device load unit. When the respective opening and closing valves are opened such that the first and second fuel battery cells are activated only at a time when a temperature detected is a low temperature, power can be supplied from two fuel battery cells to respective driver circuits in the device load unit. With such a configuration, under-detection of a fuel remaining amount detection due to a low temperature can be prevented.

Therefore, the imaging mode can be maintained even under a low temperature environment for a user without causing malfunction of the control circuit inside the device load unit. Alternatively, load fluctuation of a voltage when a strobe light is emitted from a strobe device at a time of an imaging mode becomes large, but since the fuel battery utilizes hydrogen as a fuel, power generating efficiency thereof is higher than that of a fuel battery utilizing methanol as the fuel so that former fuel battery can accommodate such a load fluctuation.

Since the number of members for the device load unit can be reduced by utilizing the temperature sensor as a temperature detecting sensor for temperature correction for an auto-focus module unit too, the device load unit in the present embodiment can be manufactured at low cost.

As another specific example, there is a cradle device for non-contact charging (for example, Jpn. Pat. Appln. KOKAI Publication No. 2006-203997 or Jpn. Pat. Appln. KOKAI Publication No. 2006-353094). Here, two fuel batteries different in kind can be used as a power source for the cradle device for non-contact charging. The cradle device for non-contact charging is provided with a recognition sensor for recognizing a weight or an outer shape of the device load unit, and a primary coil.

In a cradle device provided with a portion on which a device load unit is placed, a device load unit (for example, an electronic camera) is put on a cradle device for non-contact charging (not shown) provided in the cradle device. Thereby, a secondary battery incorporated in the device load unit is charged. The cradle device for non-contact charging inside the cradle device is incorporated with a primary coil and two different kinds of fuel batteries for exciting the primary coil by direct current.

Further, when a wake-up time or a charging time is set, a single fuel battery serving as a power source for supplying power to a backlight for timer display and a single fuel battery for exciting a primary coil by direct current may be incorporated in the cradle device. The device load unit is incorporated with a secondary coil electromagnetically coupled to the primary coil in the cradle device for non-contact charging and a charging control circuit for controlling charging state of the secondary coil. When the device load unit is loaded on the cradle device for non-contact charging of the cradle device, direct power is induced in the secondary coil incorporated in the device load unit and is controlled by a charging control circuit so that the secondary battery incorporated in the device load unit can be charged.

A control circuit provided with a protection circuit where a switching element is switched from ON to OFF when the secondary battery is fully charged can be provided instead of the timer display for charging time setting.

Further, communication means is provided between the cradle device and the device load unit, and the following operation can be performed in a state that the first fuel battery has been connected to the secondary battery of the device load unit. That is, when the remaining amount of the first fuel battery is a predetermined amount or less, the control circuit shuts off the fuel battery cell and the secondary battery from each other. After power supply to the secondary battery is stopped, a signal requesting supply start of power from the second fuel battery inside the cradle device is transmitted to the secondary battery in the device load unit via the communication means. With such a configuration, replenishment of power to the secondary battery in the device load unit is made possible.

The abovementioned second selector switch is provided for switching a remaining amount of the fuel battery from the device load unit to the secondary battery at a time of high temperature and high pressure generation of the fuel tank. In the high temperature and high pressure state of the fuel tank, an output signal from the first or second pressure sensor for detection is input into the CPU and an instruction is issued to a switching drive circuit (not shown) such that the CPU activates the second selector switch. After power ON by a user is confirmed, the CPU monitors an output signal from the first or second pressure sensor for detection connected to the fuel tank (hydrogen storing alloy container) selected according to the instruction from the CPU.

When the output signal is a predetermined value or less, after the CPU opens the first or second opening and closing valve, it starts control of the first or second pressure adjusting valve. Hydrogen gas from the selected fuel tank flows from the first or second pressure adjusting valve to the fuel battery cell. When a pressure value actually measured in a fluid flow passage positioned between the fuel battery and the pressure adjusting valve reaches a predetermined value exceeding a pressure which the pressure adjusting valve can tolerate or more, the safety valve can be opened to transfer hydrogen gas to the outside so that the pressure adjusting valve can be protected.

Incidentally, two fine fluid flow passages connected from a plurality of fuel tanks to the respective fuel battery cells have been explained, but the first selector switch can be removed by configuring a fine fluid flow passage connecting a single fuel tank and a single fuel battery cell to each other so that a configuration of a fuel battery system provided with a simplified fine fluid flow passage can be achieved.

Next, a modification of the third embodiment will be explained.

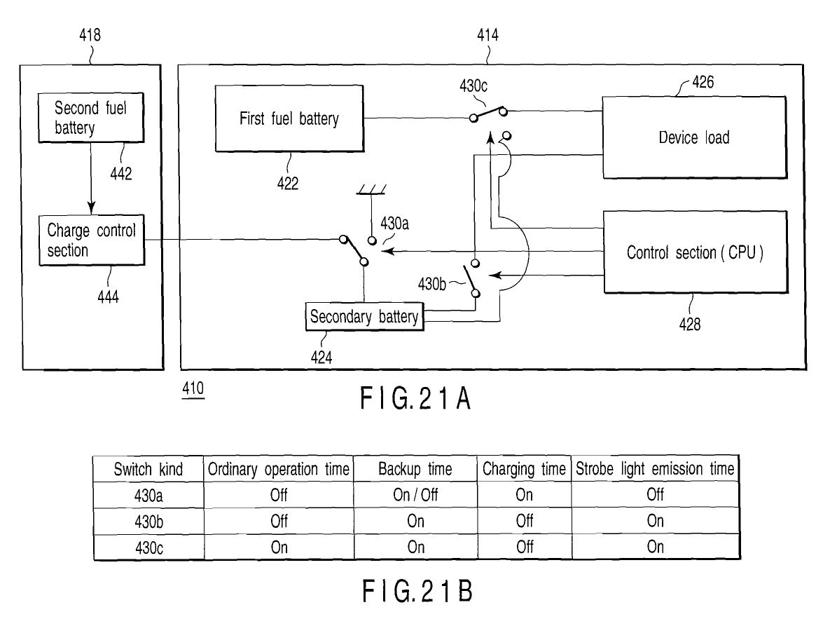

FIG. 21A is a block diagram showing a configuration of electronic device system as a modification of the third embodiment of the present invention.

In FIG. 21A, the electronic device system is configured such that a first fuel battery is loaded in a battery accommodating chamber in a device load unit and a second fuel battery is loaded in a battery accommodating chamber in a cradle device.

That is, an electronic device system 410 is configured so as to include a device load unit 414 and a cradle device 418.

The device load unit 414 comprises a first fuel battery 422, a secondary battery 424, a device load (for example, an optical disc drive device, a zoom lens drive device, a focus drive device, or the like) 426, a control section (CPU) 428, and three switches 430a, 430b, and 430c. Switching terminals of the three switches 430a, 430b, and 430c are controlled by the CPU 428.

As shown in Table in FIG. 21B, the switches 430a and 430b of these switches 430a, 430b, and 430c are turned OFF and the switch 430c is turned ON during ordinary operation (the cradle device 418 is detachable). All of the switches 430a to 430b are turned ON at a backup time (the cradle device 418 can be used in a connected state and in a non-connected state), while the switch 430a is turned ON and the switches 430b and 430c are turned OFF during charging.

Incidentally, the switch 430a is turned OFF and the switches 430b and 430c are turned ON at a time of strobe light emission. Especially, when power of the secondary battery is supplied according to load fluctuation at a strobe light emission, the power characteristic of the fuel battery can be backed up.

The cradle device 418 is configured to include a second fuel battery 442 and a charge control section 444. The secondary battery 442 comprises, for example, a lithium-ion battery or nickel hydrogen battery. Here, though not illustrated, the charge control section 444 comprises a CPU, a DC-DC converter, and an electromagnetic relay. When a remaining amount of the secondary battery 424 on the side of the device load unit 414 becomes insufficient, a request signal of power supply is transmitted from the CPU 428 on the side of the device load unit 414 to the CPU on the side of the cradle device 418. The CPU on the side of the cradle device 418 drives the DC-DC converter to perform power supply to the secondary battery 424 after receiving the signal.

Thereafter, an inquiry signal about whether or not the secondary battery 424 is in a fully-charged state is periodically transmitted from the CPU on the side of the cradle device 418 to the CPU 428 on the side of the device load unit 414. When the secondary battery 424 is fully charged, information of the fully-charged state is transmitted from the CPU 428 on the side of the device load unit 414 to the CPU on the side of the cradle device 418. The CPU on the side of the cradle device 418 turns OFF the electromagnetic relay to terminate charging of the secondary battery 424.

For example, a case of a video camera of a DVD recording medium will be explained.

In a configuration of a video camera with a recording medium using a DVD±RW, a HDD storage medium, or a disc cartridge, when the first fuel battery 422 is connected to the device load 426, as shown in FIG. 21A, the second fuel battery 442 is connected to the device load unit 424 and the secondary battery 424 is also connected in parallel with the device load 426. Thereby, since data reserved in the video camera is mainly a moving image or a still image, data volume is large so that much time and power for backup are needed. In such a backup state, total power of the first fuel battery 422 controlled by a temperature detecting section including a temperature sensor disposed near a disc recording medium and the secondary battery 424 charged from the secondary battery 442 controlled by the temperature detecting section including the temperature sensor can be supplied to the video camera.

Detecting means for detecting output voltages of the first and second fuel batteries 422 and 442, and a control section 428 for controlling ON/OFF of a selector switch according to the output voltages detected by the detecting means are provided. Especially, actuation of the first fuel battery 422 is started based upon temperature detection near the medium in synchronism with the start of power adjustment of semiconductor lasers (playback light amount adjustment or variation adjustment of individual semiconductor lasers) based upon temperature detection at a rising time of the optical disc device based upon the secondary battery 232 of the device load unit 414.

Such a function is provided that when a temperature near an optical disc reaches a predetermined temperature or more due to heating, temperature information is input to the CPU 428 and connection to the device load 426 is cut off so that operations of the first and second fuel batteries 422 and 424 are shut down. Image data for storage stored in a DVD or an HDD is transferred to an external recording medium with a certain capacity to be backed up. At a storing time of the image data, power for back up can be obtained without causing fuel battery shutoff. Accordingly, photographing data is transferred to and stored in an external recording medium reliably without needing consciousness of a user.

Jpn. Pat. Appln. KOKAI Publication No. 2002-216782 discloses a fuel battery hybrid system where a fuel battery and a plurality of (three) secondary batteries to be charged thereby are connected in parallel. The system includes detecting means 39 for detecting a charging state of each secondary battery, and the detecting means 39 comprises a current sensor for detecting a current of each secondary battery, a voltage sensor for detecting a voltage of each secondary battery, and a temperature sensor for detecting a temperature of each secondary battery. Further, Jpn. Pat. Appln. KOKAI Publication No. 2002-216782 discloses managing means. Here, during a warming-up operation, a heater 6, a fuel battery 2 and/or a cooling fan 7 are driven via a warming-up operation control section 20 based upon detected temperatures from an external air temperature detecting section 16 and a cell temperature detecting section 17.

With such a configuration, a charging/discharging ability of each secondary battery can be kept constant so that overcharging or insufficient charging can be prevented.

Thus, providing the protection function for the fuel battery causes enlargement in scale of the whole system, where many temperature sensors for each secondary battery provided with the external air temperature detecting section 16, the cell temperature detecting section 17 and the temperature sensor are used. As a result, the whole apparatus is increased in size and complicated charging/discharging management is required.

In the present invention, for example, it is unnecessary to newly provide a temperature detecting section using a temperature sensor on a fuel battery or in a fuel tank, which results in reduction of the number of parts.

Further, by setting temperature detecting positions of the first fuel battery and the second fuel battery at the same place (for example, only a temperature sensor arranged near a disc recording medium or a temperature sensor arranged on the imaging device), the fuel battery is cut off in synchronism with interruption of writing photograph data into an optical disc or a magnetic disc or interruption of data transfer from the imaging device to the recording medium when an abnormal temperature occurs suddenly so that ON/OFF operation processing to the system can be simplified. Temperature compensation in the fine fluid flow passage inside the fuel battery according to a temperature upper limit value and a temperature lower limit value defining an allowable range of image recording on the recording medium is achieved, so that such a problem that image data obtained by photographing is stored in a buffer due to recording impossibility of the image data to the optical disc can be solved. In addition, even if the first or second fuel battery shutoff occurs, an operation of the device load unit can be compensated for by the remaining fuel battery.

As another specific implementation, an advantage that power can be supplied from the secondary battery to the device load unit at an actuation time of the first fuel battery and loss for rising time of the first fuel battery is removed can be achieved. After a predetermined time elapses, switching from the secondary battery in the device load unit to the first fuel battery is performed. Further, the second fuel battery can be controlled by disposing the temperature sensor near a second fuel battery accommodating chamber in a cradle device.

It is understood that a user desires the secondary battery 424 in the device load unit 414 to be charged by simply setting the device load unit (for example, a digital camera) 414 in the cradle device 418. Therefore, it is desirable for a user that the device load unit 414 is automatically charged during outdoor activity where the user cannot use AC power. When the device load unit 414 is set in the cradle device 418, the cradle device 418 supplies power from the fuel battery to the device load unit 414 to charge the secondary battery 424 in the device load unit 414 in a default state. When a remaining amount of the secondary battery 424 in the device load unit 414 is insufficient, charging is performed using the charging control section 444 including the secondary battery 442 provided in the cradle device 418.

The device load unit 414 and the cradle device 418 are connected to each other via an electric interface (for example, a USB interface) (not shown). After transmission/reception of inherent information such as kind, capacity, and battery temperature of the secondary battery is performed, the CPU 428 in the device load unit 414 controls charge display. The CPU 428 conducts display of a charge state (LED blinking or LED identifying such that progress of charged capacity is easily understood) on a liquid crystal display screen (not shown).

Next, the case of a Printer Dock will be explained.

In a print system where a device load unit (hereinafter, described as “digital camera”) and a printer are directly connected to each other, transfer means for transferring image information to the printer and receiving means for receiving a print termination signal transmitted from the printer are provided, a first fuel battery is disposed in the digital camera, and a second fuel battery is disposed in the printer (with a cradle), power can be supplied from a second fuel battery disposed in the printer and controlled based upon an output from a temperature detecting section including a temperature sensor disposed on an outer surface of the printer to a secondary battery in the digital camera. Since an insufficient remaining amount of the secondary battery does not occur during digital camera use and printing of image data is automatically performed, the image data can be transferred to the printer and printed therein without needing consciousness of a user.

Such a configuration can be utilized in a digital camera system having a plurality of digital cameras with a wireless communication function where at least one of the digital cameras serves as a host and the remaining digital cameras serve as slaves so that a wireless communication network where the digital cameras conduct communications mutually is realized. Further, when a device load unit having a primary battery is set, since type information about the battery is transmitted from the device load unit, charge control is not performed by the CPU on the side of the cradle device and power for operation is simply supplied to the device load unit so that display such as “charge cannot be conducted due to different kind of battery” is performed on the liquid crystal display screen of the device load unit.

In such a case that a remaining amount of the fuel battery is insufficient during charging, the power required for operation of the device load unit is preferentially provided and display can be performed on the liquid crystal screen of the device load unit after such an operation as stoppage of power supply to the secondary battery is preformed. As a result, charging of the secondary battery can be stopped without interrupting display on the liquid crystal display screen of the device load unit. Accordingly, operability and convenience for a user are improved.

It is understood that a user desires the secondary battery in the device load unit to be charged by simply setting the device load unit (for example, a digital camera) in the cradle device. Therefore, it is desirable for a user that the device load unit is automatically charged during outdoor activity where the user cannot use AC power. When the device load unit is set in the cradle device, the cradle device supplies power from the fuel battery to the device load unit to charge the secondary battery in the device load unit in a default state. When a remaining amount of the secondary battery in the device load unit is insufficient, charging is performed using the charging control section including the second fuel battery provided in the cradle device.

The device load unit and the cradle device are connected to each other via an electric interface (for example, a USB interface). After transmission/reception of inherent information such as kind, capacity, and battery temperature of the secondary battery is performed, the CPU in the device load unit controls charge display. And the CPU conducts display of a charge state (LED blinking or LED identifying such that progress of charged capacity is easily understood) on a liquid crystal display screen.

Incidentally, the cradle device has been explained here, but the cradle device can be replaced by a mobile printer with a paper tray by addition of a print function for printing image data stored in a storage medium in the device load unit. It is possible to add the abovementioned contents to technical contents disclosed in a projector system provided with a fuel battery and a charging function described in Jpn. Pat. Appln. KOKAI Publication No. 2006-208832 regarding the device load unit.

The embodiments of the present invention have been explained but the present invention is not limited to the abovementioned embodiments. Naturally, the present invention can be implemented in variously modified embodiments without departing from the gist of the present invention. For example, a configuration where a glass substrate and a silicon substrate, which is a semiconductor substrate, have been joined to each other has been adopted in the embodiments, but such a configuration can be adopted that the glass substrate is replaced by a semiconductor substrate and both the semiconductor substrates are joined to each other.

Further, inventions at various steps are included in the abovementioned embodiments and various inventions can be extracted according to proper combinations of a plurality of constituent elements disclosed here. For example, even if several of the constituent elements shown in the embodiments are not used, when at least one of the problems described in BACKGROUND OF THE INVENTION can be solved and at least one of the effects described in BRIEF SUMMARY OF THE INVENTION can be achieved, a configuration where several constituent elements have been left out can be extracted as an invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fuel battery system comprising a hydrogen storing alloy container; a first pipe whose one end is connected to the hydrogen storing alloy container; a fuel battery cell; a second pipe whose one end is connected to the fuel battery cell; a fine fluid flow passage of at least one system that is disposed between the other end of the first pipe and the other end of the second pipe and includes an opening and closing valve, a pressure sensor for detection, and a pressure adjusting valve that are arranged, where the opening and closing valve or the pressure sensor for detection and a safety valve are directly connected to each other; and a temperature sensor, wherein
the temperature sensor is disposed near the fine fluid flow passage, and
in a state that the opening and closing valve being used at an occurrence time of abnormality remains open or after the opening and closing valve being used at an occurrence time of abnormality is closed according to an output from the temperature sensor, the safety valve is opened.

2. The fuel battery system according to claim 1, wherein
a retry operation is included in outputs of the temperature sensor and the pressure sensor for detection.

3. A fuel battery system comprising a hydrogen storing alloy container; a first pipe whose one end is connected to the hydrogen storing alloy container; a fuel battery cell; a second pipe whose one end is connected to the fuel battery cell; a fine fluid flow passage of a least one system and an auxiliary fine fluid flow passage, each being disposed between the other end of the first pipe and the other end of the second pipe and including an opening and closing valve, a pressure sensor for detection, and a pressure adjusting valve that are arranged, where the opening and closing valve or the pressure sensor for detection and a safety valve are directly connected to each other; and a temperature sensor, wherein
the temperature sensor is disposed near the fine fluid flow passage, and
according to an output from the temperature sensor, the opening and closing valve in either of the fine fluid flow passages and the safety valve in the auxiliary fine fluid flow passage is opened.

4. The fuel battery system according to claim 3, wherein
a retry operation is included in outputs of the temperature sensor and the pressure sensor for detection.

5. The fuel battery system according to claim 3, further comprising a silicon substrate on which the opening and closing valve, the pressure sensor for detection, and the pressure adjusting valve are formed and which is joined to a silicon substrate, wherein
the silicon substrate includes a first silicon substrate forming a lower layer for the fine fluid flow passages on the glass substrate and a second silicon substrate forming an upper layer for the fine fluid flow passages, and the pressure sensor for detection, the pressure adjusting valve, and the safety valve are disposed on the second silicon substrate, and
the temperature sensor is disposed on the glass substrate via the first and second silicon substrates.

6. The fuel battery system according to claim 5, further comprising a secondary battery, a device load unit, a storage unit having a pressure-remaining amount diagram regarding a plurality of temperature characteristics, and a selector switch arranged between the device load unit and the secondary battery, and the fuel battery cell.

7. The fuel battery system according to claim 6, further comprising an electronic device placement unit on which the device load unit is placed.

8. A device for a terminal using the fuel battery system according to claim 5, further comprising a secondary battery, a device load unit, a storage unit having a pressure-remaining amount diagram regarding a plurality of temperature characteristics, and a selector switch arranged between the device load unit and the secondary battery, and the fuel battery cell.

9. A device for a terminal using the fuel battery system according to claim 8, which is an electronic device placement unit on which the device load unit is placed.

10. A device for a terminal provided with a fuel battery system comprising a hydrogen storing alloy container, a first pipe whose one end is connected to the hydrogen storing alloy container, a fuel battery cell, a second pipe whose one end is connected to the fuel battery cell, and a fine fluid flow passage of at least one system and an auxiliary fine fluid flow passage, each being disposed between the other end of the first pipe and the other end of the second pipe and including an opening and closing valve, a pressure sensor for detection, and a pressure adjusting valve that are disposed between the hydrogen storing alloy container and the fuel battery cell, where the opening and closing valve or the pressure sensor for detection and a safety valve are directly connected to each other and disposed; a secondary battery; a temperature sensor for a unit; and a control circuit, wherein
when the control circuit determines that a temperature in the fuel battery system is abnormal based upon an output signal from the temperature sensor for a unit, the control circuit opens the safety valve in a state that the opening and closing valve being used remains open or after closing the opening and closing valve being used.

11. The device for a terminal according to claim 10, further comprising a device load unit, wherein
the control circuit shuts off the fuel battery system and the device load unit from each other based upon an output signal from the temperature sensor for a unit.

12. The device for a terminal according to claim 11, further comprising an electronic device placement unit.

13. The device for a terminal according to claim 12, wherein
the electronic device placement unit includes the fuel battery system and a charge control circuit.

14. The device for a terminal according to claim 10, wherein
the temperature sensor for a unit is disposed near a battery accommodating chamber, near a disc, near an imaging device, or on an IC chip for a lens driving circuit.

15. The device for a terminal according to claim 14, further comprising an electronic device placement unit.

16. The device for a terminal according to claim 15, wherein
the electronic device placement unit includes the fuel battery system and a charge control circuit.

17. The device for a terminal according to claim 14, wherein
when the temperature sensor for a unit detects a temperature exceeding a reference temperature, the selector switch is connected to the secondary battery and the opening and closing valve is closed to stop fuel supply to the fuel battery cell.

18. A device for a terminal comprising a fuel battery system comprising a fine fluid flow passage of at least one system and an auxiliary fine fluid flow passage, each including an opening and closing valve, a pressure sensor for detection, and a pressure adjusting valve that are disposed between a hydrogen storing alloy container and a fuel battery cell; a secondary battery; a temperature sensor for a unit, and a control circuit, wherein
when the control circuit determines that a temperature in the fuel battery system is abnormal based upon an output signal from the temperature sensor for a unit, the control circuit closes the opening and closing valve in either of the fine fluid flow passages and opens the safety valve in the auxiliary fine fluid flow passage after closing the opening and closing valve being used.

19. The device for a terminal according to claim 18, further comprising a device load unit, wherein
the control circuit shuts off the fuel battery system and the device load unit from each other based upon an output signal from the temperature sensor for a unit.

20. The device for a terminal according to claim 19, further comprising an electronic device placement unit.

21. The device for a terminal according to claim 20, wherein
the electronic device placement unit includes the fuel battery system and a charge control circuit.

22. The device for a terminal according to claim 18, wherein
the temperature sensor for a unit is disposed near a battery accommodating chamber, near a disc, near an imaging device, or on an IC chip for a lens driving circuit.

23. The device for a terminal according to claim 22, further comprising an electronic device placement unit.

24. The device for a terminal according to claim 23, wherein
the electronic device placement unit includes the fuel battery system and a charge control circuit.

25. The device for a terminal according to claim 22, wherein
when the temperature sensor for a unit detects a temperature exceeding a reference temperature, the selector switch is connected to the secondary battery and the opening and closing valve is closed to stop fuel supply to the fuel battery cell.
